(19) United States
(12) Patent Application Publication
(10) Pub. No.: US 2016/0246234 A1
(43) Pub. Date: Aug. 25, 2016

(54) MEASUREMENT APPARATUS, MEASUREMENT METHOD, AND IMAGE FORMING APPARATUS

(71) Applicant: CANON KABUSHIKI KAISHA, Tokyo (JP)

(72) Inventor: Kunitoshi Aoki, Tokyo (JP)

(21) Appl. No.: 15/050,585

(22) Filed: Feb. 23, 2016

(30) Foreign Application Priority Data
Feb. 25, 2015 (JP) 2015-035627

(51) Int. Cl. G03G 15/00

(52) U.S. Cl. CPC G03G 15/556

(57) ABSTRACT

Light is illuminated to a surface of an image carrying member which is moved, and a patch formed on the image carrying member so as to obtain an intensity distribution of reflected light from the surface of the image carrying member and the patch. A representative reflection position of the reflected light from the patch is obtained based on the intensity distribution. A light quantity of the reflected light from the patch is obtained based on the intensity distribution. An average height of the patch is calculated based on the light quantity and the representative reflection position.

### BACKGROUND OF THE INVENTION

1. Field of the Invention

The present invention relates to a technique of measuring the height of a patch formed on an image carrying member using toner.

2. Description of the Related Art

The color of an image formed by an image forming apparatus using an electrophotographic method varies due to various physical factors even if settings of the apparatus are constant at the time of image formation. Especially, a developing process and transfer process largely influence variations in color. This is because the latent image potential, toner supply amount, transfer efficiency, and the like change due to environmental variations such as variations in temperature and humidity, and the amount (to be referred to as a “toner apply amount” hereinafter) of toner applied to a photosensitive drum or transfer belt is unstable.

To cope with this, there is provided a technique of measuring the toner apply amount, performing feedback control of an exposure amount, developing voltage, transfer current, and the like based on the measurement result, and stabilizing the developing process and transfer process. In general, such feedback control is performed when the printer environment varies, for example, after replacement of a toner cartridge, after printing of a predetermined number of sheets, or after power-on of a printer main body. To measure the toner apply amount, a plurality of patches of various densities from a low density to a high density are formed on the photosensitive drum or transfer belt. The toner apply amounts of the patches are measured and a proper image forming condition is set based on the measurement result.

Japanese Patent Laid-Open Nos. 62-280869 (literature 1) and 3-209281 (literature 2) disclose methods of detecting a reflected light quantity when the surface of a photosensitive drum or transfer belt is illuminated with light and that when a patch is illuminated with light, and indirectly measuring a toner apply amount using the difference between the detected reflected light quantities as a reflection density.

Japanese Patent Laid-Open No. 8-327331 (literature 3) discloses a method of detecting a toner apply amount by measuring the height of a patch by a laser displacement meter. According to literature 3, an image carrying member is illuminated with spot light, and an image of reflected light from the image carrying member is focused. The focus position of the reflected light is a position corresponding to the height of a patch on the image carrying member. Thus, a position at which the intensity of the reflected light is highest is detected from a reflection image obtained by an image capturing device such as a CCD, and the height of the patch is directly measured based on the change amount of the detected position.

In the methods of measuring a toner apply amount by a light quantity detection scheme described in literatures 1 and 2, when measuring a patch with a large toner apply amount, such as a solid image, a change in reflected light quantity signal with respect to a change in toner apply amount becomes small, thereby decreasing the detection sensitivity. Therefore, when measuring a patch of a high density, the measurement method using a position detection scheme described in literature 3 can measure a toner apply amount with higher accuracy.

According to Japanese Patent Application No. 2009-103360 (literature 4), a toner apply amount is satisfactorily measured from a low density to a high density by obtaining both information of a reflected light quantity and information of a reflection position by one sensor, and selecting information to be used to measure a toner apply amount in accordance with the set density of a formed patch. However, with respect to a patch of a low density, a toner apply amount is indirectly measured as a reflection density based on the reflected light quantity instead of directly measuring the height of the patch.

Patches to be measured include a patch having a structure including an exposed portion and toner covering portion of an image carrying member to express an intermediate density. If the height of a patch of an intermediate density, which moves along with conveyance of the image carrying member, is measured by the reflection position scheme, the exposed portion and toner covering portion of the image carrying member are alternately illuminated with spot light emitted by a light source. Reflected light from the exposed portion and that from the toner covering portion sequentially reach the image capturing device, charges are stored for a predetermined storage time, and the stored charges are periodically converted into an electrical signal.

If the storage time of the image capturing device can be made sufficiently shorter than a period (to be referred to as an “illumination period” hereinafter) during which the exposed portion and toner covering portion of the image carrying member are alternately illuminated by spot light, it is possible to obtain information of a reflection position in accordance with each height by reflected light from the exposed portion and that from the toner covering portion. Therefore, it is possible to readily calculate the correct average height of the patch by averaging heights represented by the pieces of information of the reflection positions. However, an image capturing device operating at a high frame rate is necessary to implement such measurement, and is not practical because of an increase in cost.

If the storage time of the image capturing device is longer than the illumination period, reflected light from the exposed portion and that from the toner covering portion overlap each other within the same storage time, thereby obtaining a reflection image in which the reflected light from the exposed portion and the reflected light from the toner covering portion are blended. Since the position at which the intensity of the reflected light is highest in this reflection image changes due to the influences of the ratio between the reflected light quantities of the exposed portion and toner covering portion of the image carrying member and the toner deposition state of the toner covering portion, it does not always indicate the correct average height of the patch. Consequently, if an image capturing device operating at a general frame rate is used to measure a toner apply amount, simply calculating a reflection position causes an error.

### SUMMARY OF THE INVENTION

In one aspect, a measurement apparatus for measuring an average height of a patch formed on an image carrying member using a toner, and a tonality of the patch being determined by a deposition state of the toner, the apparatus comprising: a measurement unit configured to illuminate light with a surface of the image carrying member which is moved, and a patch formed on the image carrying member so as to obtain an intensity distribution of reflected light from the surface of the image carrying member and the patch; a first obtaining unit configured to obtain a representative reflection position of the reflected light from the patch based on the intensity distribution; a second obtaining unit configured to obtain a light quantity of the reflected light from the patch based on the intensity distribution; and a calculation unit configured to calculate the average height of the patch based on the light quantity and the representative reflection position.

According to the aspect, it is possible to correctly measure the average height of a patch which is formed on an image carrying member using toner and whose tonality is determined by a deposition state of the toner.

Further features of the present invention will become apparent from the following description of exemplary embodiments with reference to the attached drawings.

### BRIEF DESCRIPTION OF THE DRAWINGS

FIGS. 1A and 1B are views each showing an overview of the arrangement of a printing apparatus.

FIG. 2 is a block diagram for explaining feedback control in an image forming process.

FIG. 3 is a view showing the arrangement of a toner apply amount measurement apparatus.

FIGS. 4A and 4B are views for explaining a method of measuring profile data indicating the surface shape of an image carrying member.

FIG. 5 is a view showing an example of the reflection waveform of a solid patch.

FIG. 6 is a view showing an example of the reflection waveform of the solid patch when a storage time is long.

FIGS. 7A to 7C are views for explaining the measurement value of the average height and the reflected light quantity of a patch in a simple deposition model.

FIG. 8 is a block diagram showing the arrangement of a signal processing unit for calculating a toner apply amount.

FIG. 9 is a flowchart illustrating processing by a measurement unit.

FIGS. 10A and 10B are views for explaining a three layer deposition model.

FIGS. 11A and 11B are views for explaining the measurement value of the average height and the reflected light quantity of a patch in the three layer deposition model.

FIGS. 12A and 12B are flowcharts illustrating processing by a measurement unit according to the second embodiment.

FIGS. 13A and 13B are views for explaining a reflection waveform in a spherical toner deposition model.

FIGS. 14A and 14B are views for explaining the measurement value of the average height and the reflected light quantity of a patch in the spherical toner deposition model.

FIGS. 15A to 15C are views for explaining a method of correcting the measurement value of an average height according to the third embodiment.

FIG. 16 is a flowchart illustrating processing by a measurement unit according to the third embodiment.

FIGS. 17A and 17B are views for explaining the shape of a reflection waveform.

FIGS. 18A and 18B are views for additionally explaining a storage operation in an image capturing device.

FIG. 19 is a table showing the transmittance of light which is transmitted through each layer in each stack state.

### DESCRIPTION OF THE EMBODIMENTS

Embodiments of the present invention will be described below with reference to the accompanying drawings. Note that the following embodiments are not intended to limit the scope of the appended claims, and that not all the combinations of features described in the embodiments are necessarily essential to the solution of the present invention.

### First Embodiment

The first embodiment will describe an example in which a simple toner deposition state is estimated based on the characteristic of the reflected light quantity of an image carrying member on which a patch representing tonality by deposition of toner is formed, and a measured average height of toner is corrected.

[Apparatus Arrangement]

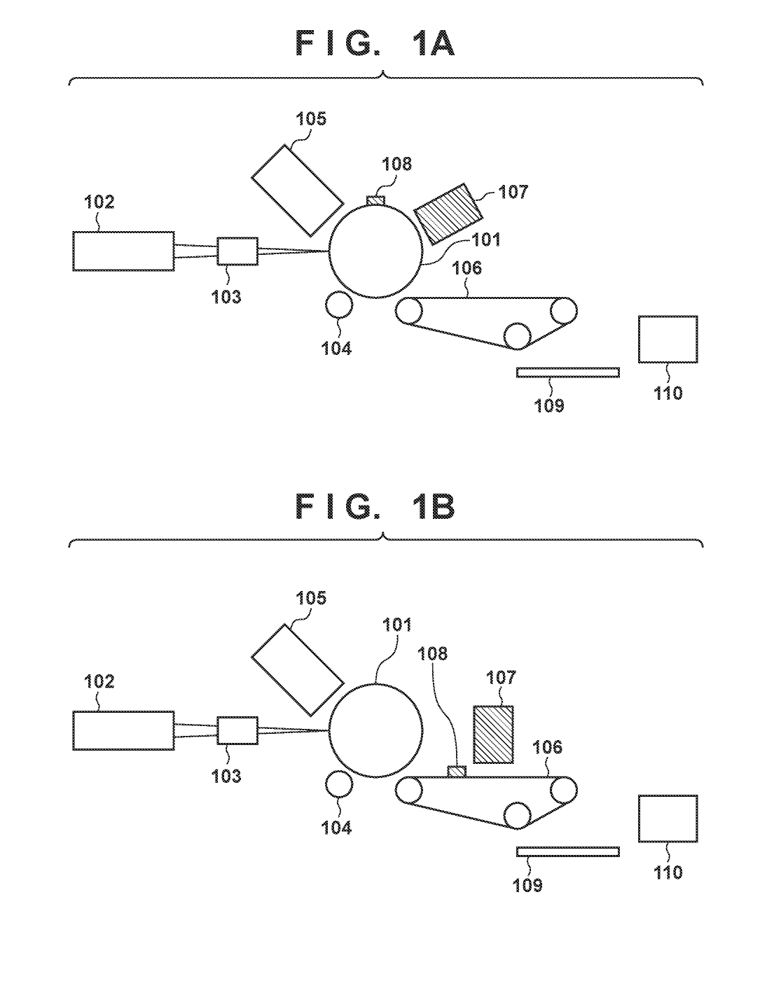

FIG. 1A is a view showing an overview of the arrangement of an image forming apparatus (to be referred to as a “printing apparatus” hereinafter) using an electrophotographic method.

The printing apparatus includes a photosensitive drum 101 serving as an image carrying member, an exposure laser light source 102, a polygon mirror 103, a charging roller 104, a developing device 105, a transfer belt 106, a toner apply amount measurement apparatus 107, and a fixing device 110 for fixing a toner image transferred to a printing sheet 109.

When measuring a toner apply amount, the charging roller 104 charges the surface of the photosensitive drum 101, and the exposure laser light source 102 and the polygon mirror 103 create an electrostatic latent image of a patch on the surface of the photosensitive drum 101. The developing device 105 develops the electrostatic latent image on the photosensitive drum 101 to form a patch 108, and the measurement apparatus 107 installed at a position facing the patch 108 after development measures the toner apply amount of the patch 108.

The measurement position of the patch is not limited to the example shown in FIG. 1A. As shown in FIG. 1B, for example, after the patch 108 is transferred from the photosensitive drum 101 to the transfer belt 106, a tone apply amount may be measured on the transfer belt 106. It is possible to measure a toner apply amount on the photosensitive drum 101 or the transfer belt 106, and the procedure is the same. The following description is based on FIG. 1B.

[Feedback Control]

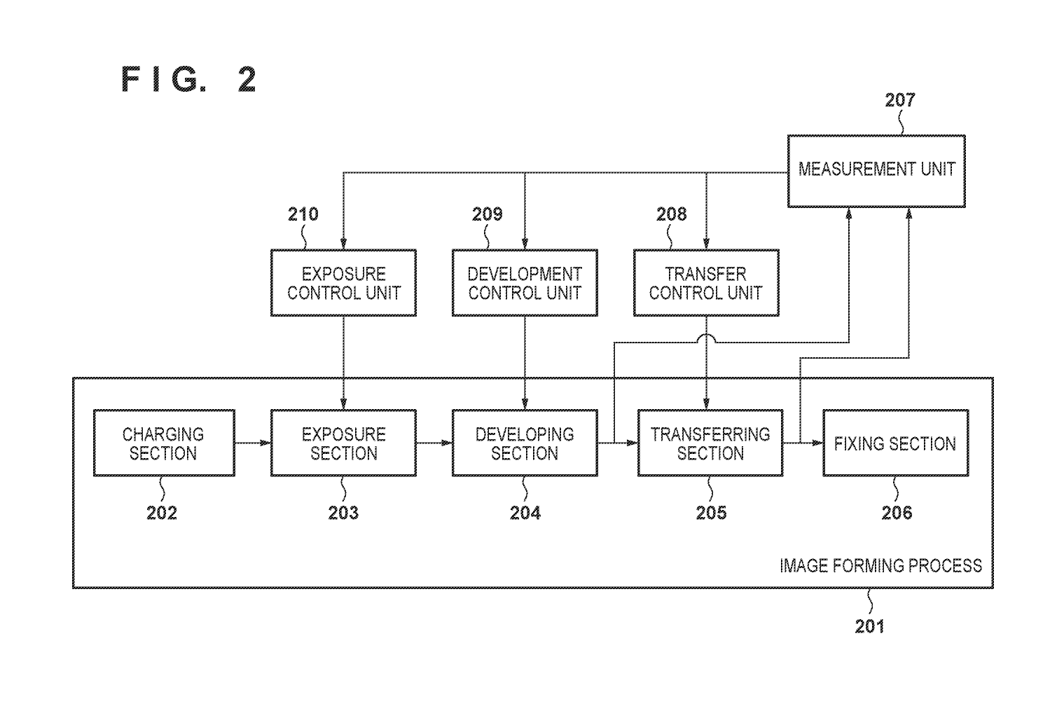

FIG. 2 is a block diagram for explaining feedback control of an image forming process 201 using a measurement unit 207 corresponding to the measurement apparatus 107.

With respect to the patch 108 after development of a developing section 204 or after transfer of a transferring section 205, the measurement unit 207 measures a toner apply amount. Feedback control of each of the processes of a transfer control unit 208, a development control unit 209, and an exposure control unit 210 is performed based on the measured toner apply amount. This suppresses variations in color of an output image in the printing apparatus, thereby implementing stabilization.

As a correction amount in this control processing, the average height of the patch 108 measured by the measurement unit 207 may be directly used to control a toner height at the time of output of the maximum density, or may be converted into a density to be used for density control. For example, it is possible to adjust the tonality (gamma characteristic) of an output density by changing the output characteristic of a laser beam in the exposure control unit 210, thereby changing the density. Furthermore, it is possible to change the toner height at the time of output of the maximum density by adjusting a development bias voltage or toner supply amount by the development control unit 209 or adjusting a transfer current to a proper setting value in the transfer control unit 208.

[Sensor Arrangement]

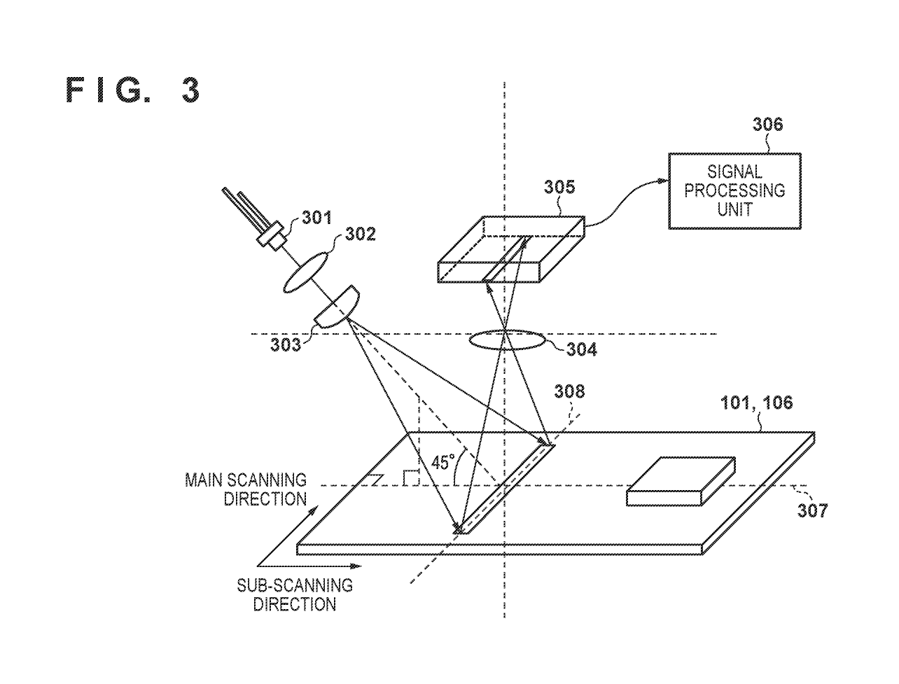

FIG. 3 is a view showing the arrangement of the measurement apparatus 107.

The measurement apparatus 107 includes a laser light source 301 for illuminating the image carrying member (photosensitive drum 101 or transfer belt 106) with light, and a condenser lens 302 for condensing laser beams on a spot. Furthermore, a cylindrical lens 303 is arranged between the condenser lens 302 and the image carrying member. The cylindrical lens 303 is arranged in a direction so as to spread, in the direction of a main-scanning axis 308, the spot condensed on the image carrying member, and the image carrying member is illuminated with slit-shaped light (to be referred to as “slit light” hereinafter) extending in the main scanning direction.

The optical axes of these optical parts for forming slit light are set at an elevation angle of about 45° from the plane of the image carrying member which is parallel to a sub-scanning axis 307 as the moving direction of the image carrying member. Therefore, if the height of a slit light illuminated surface (reflection surface) in this arrangement changes, the reflection position of the slit light changes in a direction parallel to the sub-scanning axis 307.

To detect a change in position in the sub-scanning direction of the slit light extending in the main scanning direction, an area image sensor (to be referred to as an “area sensor” hereinafter) in which pixels are two-dimensionally arranged is used as an image capturing device 305. A light receiving lens 304 forms an image of reflected light on the image capturing device 305, and a reflection image of the slit light obtained by the image capturing device 305 is stored in a signal processing unit 306, and then used to calculate a toner apply amount.

Note that if only the reflection position in the sub-scanning direction corresponding to the height of the reflection surface is detected, an arrangement of one-dimensionally detecting reflected light of spot light by a line image sensor may be adopted. If the slit light extending in the main scanning direction and the area sensor are used as described above, an amount of data (signal amount) to be obtained increases, and thus a signal noise ratio (S/N) improves.

[Method of Measuring Profile Data]

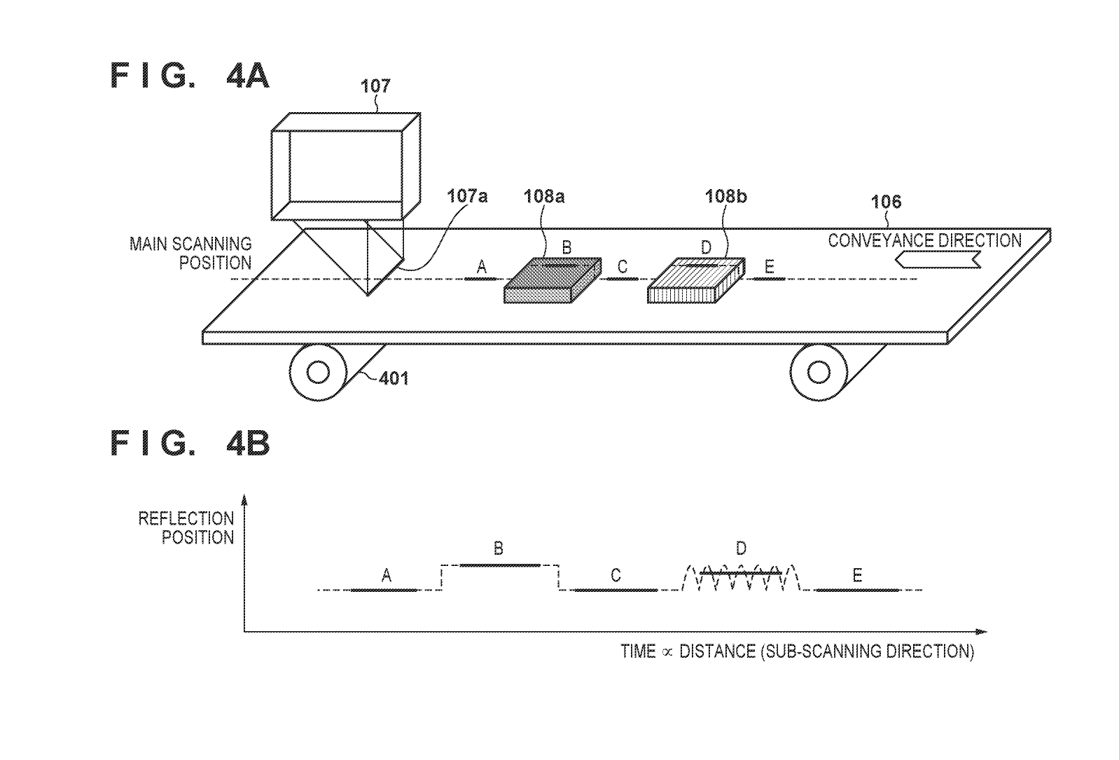

A method of measuring profile data indicating the surface shape of the image carrying member will be described with reference to FIGS. 4A and 4B.

The image capturing device 305 (to be referred to as the “area sensor” hereinafter) repeats an operation of storing charges proportional to an incident light quantity for a predetermined time based on a set sampling frequency, and outputting image data representing the stored charge amount for each frame.

As shown in FIG. 4A, the image carrying member 106 is conveyed in the sub-scanning direction at a predetermined process speed by driving rollers 401 while carrying patches 108a and 108b. Therefore, the signal processing unit 306 successively stores image data (to be referred to as “reflection waveforms” hereinafter) indicating a change in reflection position on the image carrying member 106 and the patches 108a and 108b at predetermined sampling intervals.

The signal processing unit 306 starts to store an image capturing waveform from the area sensor 305 at position A in the conveyance direction where no patch is formed. Image data indicating the reference height of the image carrying member 106 is stored first, and then image data at position B where the patch 108a is formed, image data at position C on the surface of the image carrying member 106, image data at position D where the patch 108b is formed, and image data at position E on the surface of the image carrying member 106 are stored.

By performing signal processing (to be described later) for the thus obtained image data (reflection waveforms) indicating a change in reflection position, the reflection position in the sub-scanning direction of slit light 107a is detected, and the height of each of the patches 108a and 108b is calculated as a change amount from the reflection position in a non-patch forming portion of the image carrying member 106 serving as a reference surface. Using the average values of reflection positions at the plurality of measurement positions (A, C, and E) on the image carrying member 106 and the average values of reflection positions at the measurement positions (B and D) on the respective patches, heights h_{P108a} and h_{P108b} of the patches 108a and 108b can be calculated by:

h_{P108a}=h_{B}−(h_{A}+h_{C})/2;

h_{P108b}=h_{D}−(h_{C}+h_{E})/2; (1)

where h_{A}, h_{B}, h_{C}, h_{D}, and h_{E} represent the average values of the reflection positions at measurement positions A, B, C, D, and E, respectively.

In this way, profile data shown in FIG. 4B and indicating the surface shape at a given main scanning position on the image carrying member 106 is obtained.

Note that as a typical shape of a patch, there is a patch (to be referred to as a “screen patch” hereinafter) having a structure including the exposed portion and toner covering portion of the image carrying member in addition to a patch (to be referred to as a “solid patch” hereinafter) indicating the highest density by covering the entire image carrying member with a toner layer. Referring to FIG. 4A, the patch 108a is an example of the solid patch and the patch 108b is an example of the screen patch. To correctly measure the average height of the patch 108b, it is necessary to emit the slit light 107a condensed in the sub-scanning direction to have a pitch sufficiently smaller than the smallest pitch of a screen line, and set the storage time of the area sensor 305 shorter than a period during which the exposed portion and toner covering portion of the image carrying member are alternately illuminated with the slit light 107a.

[Reflection Image of Solid Patch]

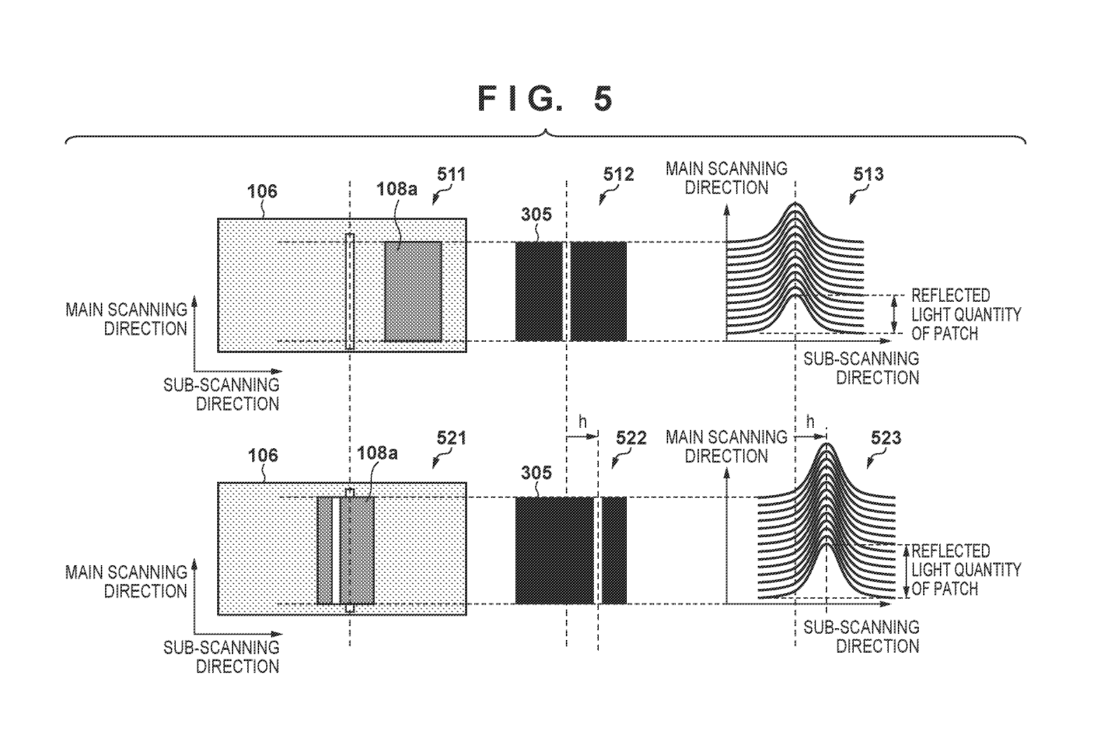

A reflection waveform in measurement of the solid patch will be described with reference to FIG. 5.

When the surface of the image carrying member 106 is illuminated with the slit light 107a as denoted by reference numeral 511, a reflection image of the slit light 107a is formed at a given position in the area sensor 305 as denoted by reference numeral 512.

When a light quantity distribution in the sub-scanning direction is seen by focusing attention on the pixel array of one pixel in the main scanning direction of the reflection waveform obtained by the area sensor 305, a reflection waveform having a Gaussian distribution shape in which a position corresponding to the center of the slit light 107a is brightest and the brightness decreases as the distance from the center is longer is observed. The reflection waveform separated by respective pixels in the main scanning direction is schematically displayed, as denoted by reference numeral 513.

If the image carrying member 106 is conveyed in the sub-scanning direction from the state denoted by reference numeral 511, the patch 108a is illuminated with the slit light 107a, as denoted by reference numeral 521. In this case, since a portion in which the patch 108a is formed has a reflection surface higher than the surface of the image carrying member 106 by the height of the patch 108a, the reflection position of the slit light 107a shifts in the horizontal direction.

Since an image of the reflected light is formed on the area sensor 305 as an inverted real image by the light receiving lens 304, the area sensor 305 forms an image of the reflected light at a position shifted in a direction opposite to the shift direction of the reflection position by a shift amount h, as denoted by reference numeral 522. Note that the enlargement ratio of the light receiving lens 304 is ×1. In this case, when the light quantity distribution in the sub-scanning direction is seen by focusing attention on the pixel array of one pixel in the main scanning direction, a reflection waveform having a Gaussian distribution shape is observed as described above, as denoted by reference numeral 523. Note that the whole reflection waveform shifts in the sub-scanning direction by the shift amount h corresponding to the height of the patch 108a.

It is possible to measure the height of the patch when the signal processing unit 306 calculates positions in the sub-scanning direction of these reflection waveforms each having the Gaussian distribution shape. The position of the waveform in the sub-scanning direction can be represented by coordinates corresponding to a pixel array in the sub-scanning direction of the area sensor 305, and the height of the patch 108a can be calculated by calculating the coordinates of the peak of the reflection waveform having the Gaussian distribution shape, the coordinates of the barycenter of the whole waveform, or the like.

Note that when the reflection waveforms 513 and 523 each having the Gaussian distribution shape in FIG. 5 are compared with each other, a change in waveform, which is associated with the reflected light quantity, such as a change in height or area of the waveform is observed in addition to the shift in the sub-scanning direction. While the surface of a general image carrying member is relatively smooth and has many regular reflection components, the patch surface has a three-dimensional structure caused by the shapes of toner particles and has many irregular reflection components. Therefore, in this arrangement of condensing irregularly reflected light by the light receiving lens 304, the area of the reflection waveform corresponding to a light quantity when the patch is illuminated with the slit light 107a becomes large.

[Method of Detecting Peak Position of Waveform]

As a method of calculating the peak position of the waveform with the Gaussian distribution shape, there is provided, for example, a calculation method of performing curve fitting by the least squares method using a Gaussian function. The Gaussian function is given by:

$$f ( x ) = \frac{A}{\sqrt{2 π {σ}^{2}}} exp \{ - \frac{{( x - μ )}^{2}}{2 {σ}^{2}} \} + C \qquad ( 2 )$$

Curve fitting calculates parameter values (A, μ, σ, and C) when the whole waveform and the Gaussian function match most. The parameter p after fitting indicates the peak position of the waveform.

Note that fitting to, for example, a Lorentz function given by equation (3) below or a quadratic function given by equation (4) below instead of the Gaussian function may be performed.

$$\begin{matrix}f ( x ) = \frac{2 A}{π} \cdot \frac{w}{4 {( x - {x}_{c} )}^{2} + {w}^{2}} + C & ( 3 ) \\ f ( x ) = {A ( x - B )}^{2} + C & ( 4 )\end{matrix}$$

Furthermore, only calculation of the barycenter of the whole waveform or detection of the maximum value may be performed without performing fitting. In function fitting or barycenter calculation, a position based on the waveform is calculated, and it is thus possible to calculate a position with accuracy finer than the pixel of the area sensor 305. In addition, for example, even the peak position of a waveform having an asymmetrically distorted shape can be calculated in consideration of the bias. These calculation methods are flexibly implemented in accordance with the calculation accuracy and a necessary calculation amount.

As described above, profile data indicating the surface shape of the image carrying member 106 shown in FIG. 4B is obtained by calculating the peak positions of all the reflection waveforms obtained in time series.

[Storage Time and Sampling Interval]

Screen lines used by a commercial printing apparatus to express an intermediate density have a pitch of several tens of μm, and the speed of the image carrying member 106 carrying the patch is about 100 to several hundred mm/sec. Consequently, to obtain a reflection waveform at the moment at which only the exposed portion or toner covering portion of the image carrying member of the screen patch is illuminated with light, an image sensor capable of obtaining an image at a sampling frequency of several kHz is required. However, an image sensor operating at such high frame rate is expensive, thereby increasing the cost of the apparatus.

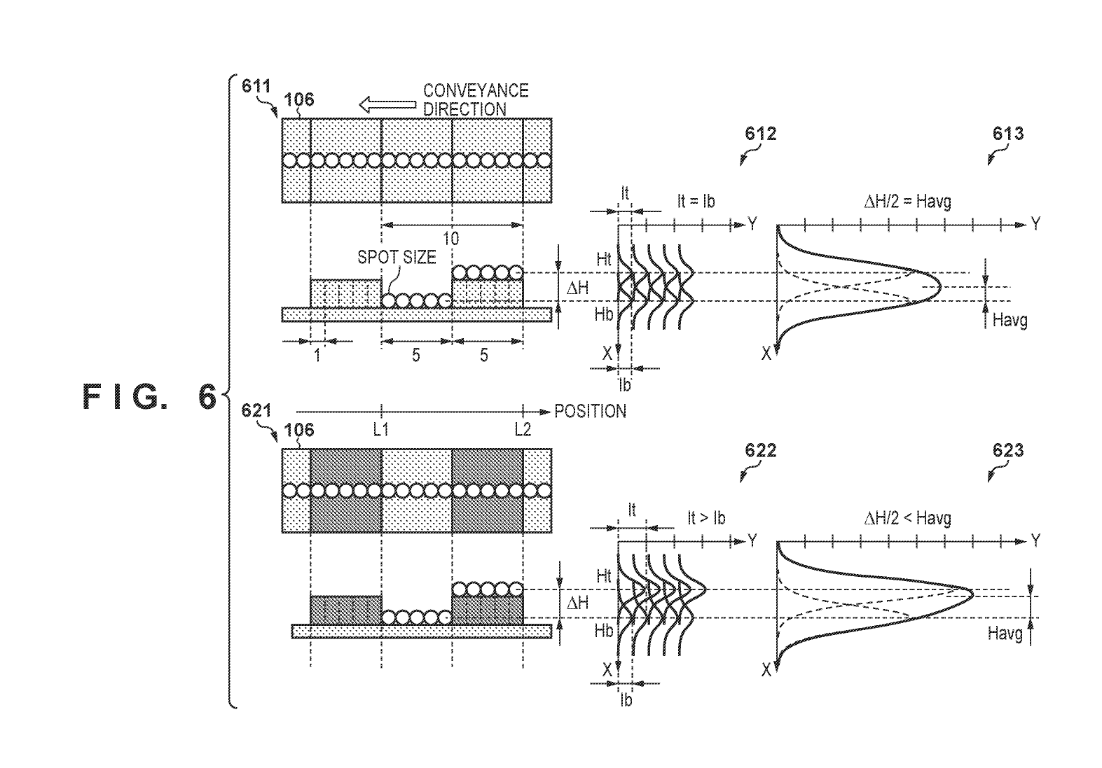

FIG. 6 shows an example of the reflection waveform of the screen patch obtained within a relatively long storage time using an image sensor operating at a general frame rate. Note that to simplify a description of the principle, FIG. 6 shows a case in which a range, corresponding to one period, of a screen from the exposed portion of the image carrying member to the toner covering portion is discretely illuminated with spot light, and reflected light beams are obtained as a set of reflection waveforms within one storage time.

Reference numeral 611 schematically denotes a case in which the screen patch 108b having a duty of 50% (the area of the exposed portion is 50% and the area of the toner covering portion is 50%) and the reflectance of toner equal to that of the surface of the image carrying member 106 is illuminated with spot light. Assume that the illumination width (spot size) in the sub-scanning direction of the spot light is “1”, the minimum width of the toner covering portion is “1”, and the screen period (the pitch of the screen lines) is “10”. Since the duty is 50%, the width of each of the exposed portion and toner covering portion of the image carrying member corresponds to five spot light beams. The difference between the height of the surface of the image carrying member and that of the patch surface is represented by ΔH.

Therefore, as denoted by reference numeral 612, five reflection waveforms each having a Gaussian distribution shape are obtained from each of positions Ht and Hb having an interval of ΔH. If the area sensor 305 starts storage at a position L1 and completes storage at a position L2, a reflection waveform finally output from the area sensor 305 is as denoted by reference numeral 613.

If a reflectance Ib of the surface of the image carrying member 106 is equal to a reflectance It of toner, charges corresponding to the same light quantity are stored in a pixel corresponding to each reflection position, and thus the center of the final reflection waveform is positioned at the middle of the positions Ht and Hb. Therefore, it is possible to detect an average height Havg=ΔH/2 of the patch with a duty of 50% by calculating a barycentric position Havg of the reflection waveform as the central position of the reflection waveform.

On the other hand, reference numeral 621 denotes a case in which the reflectance It of toner is higher than the reflectance Ib of the surface of the image carrying member 106. In this case as well, five reflection waveforms each having a Gaussian distribution shape are obtained from each of the positions Ht and Hb. However, as denoted by reference numeral 622, the peak of the reflection waveform in the toner covering portion is higher than that of the reflection waveform in the exposed portion of the image carrying member in correspondence with the reflectance It of toner higher than the reflectance Ib. Therefore, a reflection waveform finally output from the area sensor 305 is as denoted by reference numeral 623, and the barycentric position of the reflection waveform slightly shifts to the Ht side (toner covering portion side) from the middle of the positions Ht and Hb. As a result, the barycentric position Havg of the reflection waveform has a value slightly larger than the average height ΔH/2 of the patch with a duty of 50%. This is an error equally generated when an algorithm of calculating the position of the whole waveform by function fitting is used.

If the reflection waveform of the screen patch is obtained within a relatively long storage time, the difference between the reflectance Ib of the surface of the image carrying member 106 and the reflectance It of toner unwantedly changes the barycentric position of the reflection waveform. Consequently, the correct average height of the patch is not calculated by only simply calculating the barycenter of the reflection waveform. To cope with this, the barycentric position Havg of the reflection waveform is corrected in accordance with the reflectance difference. In other words, the position Havg with respect to the position Hb serving as a reference reflection position corresponding to the image carrying member 106, that is, the difference between the positions Hb and Havg is corrected.

[Deposition State and Measurement Value of Average Height]

The measurement value of the average height and the reflected light quantity of a patch in a toner deposition model (to be referred to as a “simple deposition model” hereinafter) which grows the patch by one layer will be described below.

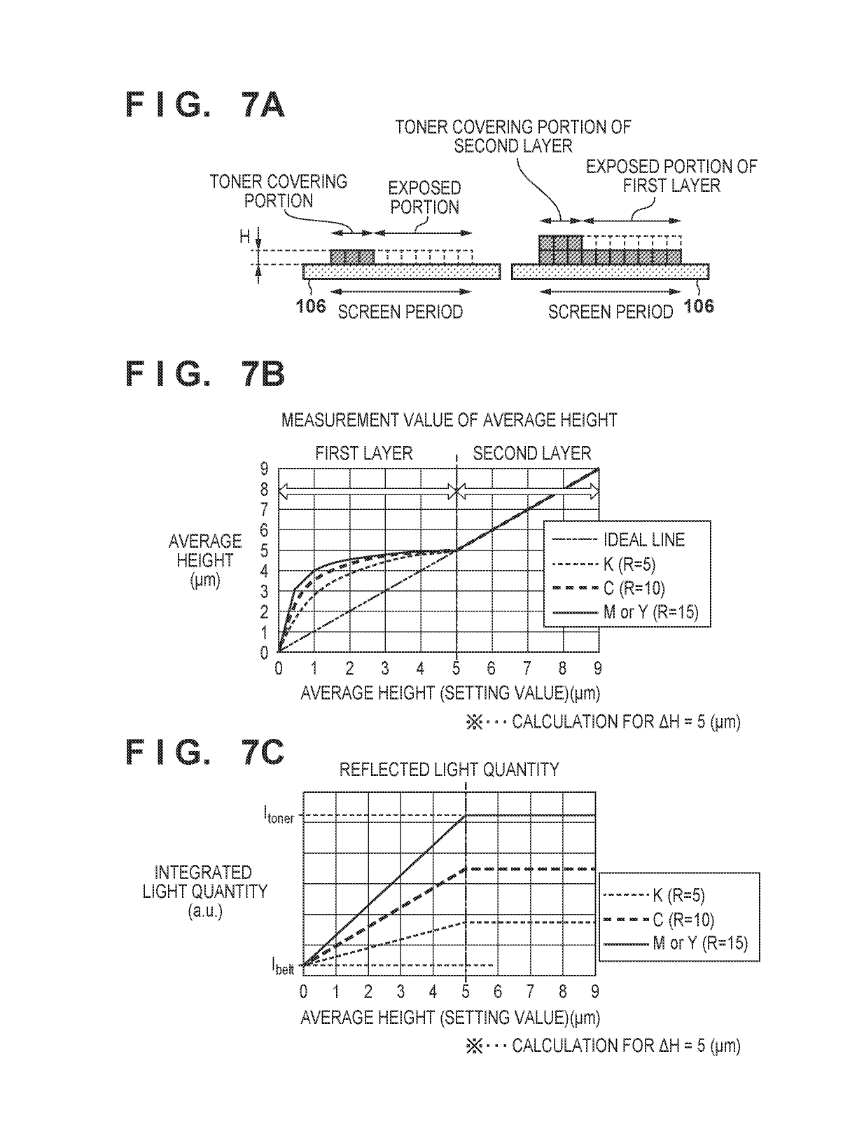

As shown in FIG. 7A, the width of a screen line gradually increases as the set density of the patch increases, and the average height of the patch increases as the duty of the exposed portion and toner covering portion of the image carrying member changes. When the set density becomes high to some extent, the first layer of the surface of the image carrying member is covered with toner to start formation of the second layer.

FIG. 7B shows the measurement value of the average height of the patch when the patch formed in the simple deposition model is measured using an image sensor whose storage time is relatively long. Referring to FIG. 7B, until the surface of the image carrying member is covered with toner, a large average height is measured due to the factor described with reference to FIG. 6.

When the surface of the image carrying member is covered with toner of the first layer to start formation of the second layer, an ideal average height is measured by the principle described with reference to FIG. 6 since the reflectance of toner of the first layer is equal to that of toner of the second layer. Therefore, a measurement value distorted in an upward convex shape with respect to an actually deposited height is obtained in a region where the first layer is deposited, and a linear measurement value equal to the actually deposited height is obtained in a region where the second layer is deposited. Furthermore, since the average height measurement error is larger as a ratio It/Ib (to be referred to as a “reflectance ratio R” hereinafter) between the reflectance Ib of the surface of the image carrying member 106 and the reflectance It of toner is higher in the region where the first layer is deposited, if toner of magenta (M) or yellow (Y) with a high reflectance ratio R is measured, distortion in an upward convex shape appears more conspicuously.

FIG. 7C shows a reflected light quantity by irregular reflection as the reflection characteristic of the patch. The reflected light quantity can be calculated by calculating the height or area of the reflection waveform. In the first layer, since the ratio at which charges corresponding to light irregularly reflected from toner are stored becomes higher as the surface of the image carrying member is covered with toner, the reflected light quantity almost linearly increases with respect to a change in area ratio of the toner covering portion. After the entire surface of the image carrying member is covered with toner, the first and second layers have the same reflectance, and thus the reflected light quantity remains unchanged, thereby presenting the saturation characteristic.

[Correction of Average Height]

A proper average height of the patch is calculated using the measurement value of the average height and the reflected light quantity in consideration of the characteristic of the measurement value of the average height and the characteristic of the reflected light quantity. The distorted portion of the measurement value of the average height shown in FIG. 7B can be represented by an equation such as a high-order polynomial or exponential function, given by:

y=a₆x⁶+a₅x⁵+a₄x⁴+a₃x³+a₂x²+a₁x+a₀ (5)

y=ae^{bx}+c (6)

Therefore, if correction is performed using the equation for each type of toner, it is possible to calculate a correct average height.

Note that as the reflectance ratio R changes with time or due to wear of the image carrying member 106, the value of each coefficient of the equation changes. It is thus necessary to hold a plurality of coefficient values within the change range of the reflectance ratio R. If the signal processing unit 306 has a sufficient storage capacity, a lookup table (to be referred to as an “LUT” hereinafter) may be held and used instead of storing the coefficients of the equation.

The reflectance ratio R can be calculated based on the reflected light quantity. The reflectance ratio R can be calculated by measuring in advance a reflected light quantity I_{belt} of the surface of the image carrying member and a reflected light quantity Iₜₒₙₑᵣ of the solid patch which is not the screen patch and is formed with maximum tonality. By appropriately selecting the coefficients of the equation (or the LUT) to be used for correction based on the reflectance ratio R measured in advance in this way, a correct average height can be calculated.

Note that since the above-described correction method is applicable to the simple deposition model in which toner is stacked for each layer, it is inappropriate for another deposition model having a different deposition state. As shown in FIG. 7C, whether the simple deposition model is used can be determined by determining whether the reflected light quantity almost linearly changes at the time of deposition of the first layer. By forming a plurality of patches while changing the duty by the same amount for each patch, and measuring the reflected light quantities of the patches, it is possible to determine whether the patch of the simple deposition model is used.

[Signal Processing Unit]

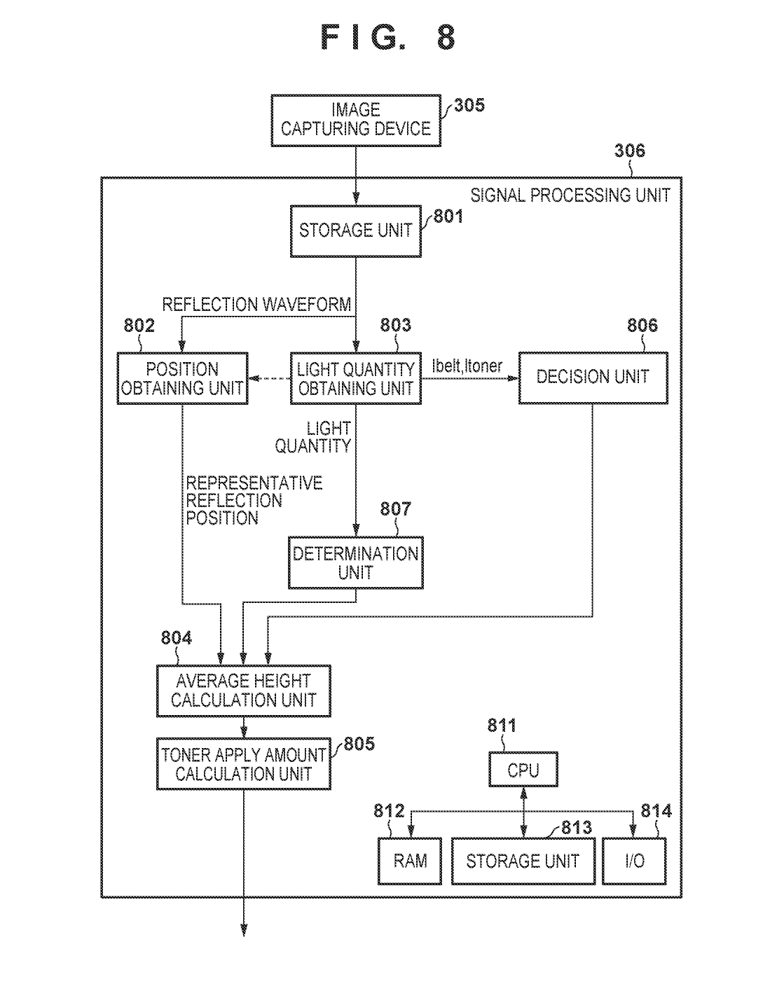

FIG. 8 is a block diagram showing the arrangement of the signal processing unit 306 for calculating a toner apply amount.

Image data output from the image capturing device 305 are stored in time series in a storage unit 801 of the signal processing unit 306. Each of a position obtaining unit 802 and a light quantity obtaining unit 803 calculates the feature amount of a reflection waveform from each stored image data, as needed.

The position obtaining unit 802 calculates the specific position (barycentric position or peak position) of the reflection waveform as the representative reflection position of the reflection waveform in the sub-scanning direction. The light quantity obtaining unit 803 calculates the height or area of the reflection waveform as a reflected light quantity.

Based on the reflectance ratio R obtained in advance for each toner color, a decision unit 806 decides an equation and coefficients or an LUT for a curve indicating the distorted portion of the measurement value of the average height of the first layer shown in FIG. 7B.

In accordance with the reflected light quantity calculated by the light quantity obtaining unit 803, a determination unit 807 controls whether an average height calculation unit 804 corrects the measurement value of the average height.

By using the equation and coefficients or the LUT decided by the decision unit 806, the average height calculation unit 804 according to determination of the determination unit 807 corrects an error caused by the above-described reflectance ratio R and included in the representative reflection position calculated by the position obtaining unit 802, thereby calculating the original average height of the patch.

Alternatively, the representative reflection position calculated by the position obtaining unit 802 is output as an average height without performing correction. Note that even if no correction is performed, the average height calculation unit 804 performs minimum processing of, for example, converting the representative reflection position into an average height by multiplying the representative reflection position by a predetermined coefficient, as needed. In other words, the average height calculated when no correction is performed is proportional to the representative reflection position.

A toner apply amount calculation unit 805 converts the calculated average height into a patch volume or mass necessary for feedback control or information such as an image density. The converted information is output to the transfer control unit 208, the development control unit 209, and the exposure control unit 210 as an output of the measurement unit 207.

Note that FIG. 8 shows an example in which the signal processing unit 306 includes the toner apply amount calculation unit 805. However, an arrangement may be adopted in which information indicating the average height is output as an output of the measurement unit 207 and the information indicating the average height is converted into a physical amount appropriate for feedback control in the transfer control unit 208, the development control unit 209, or the exposure control unit 210.

An example in which the position obtaining unit 802 calculates the specific position of the reflection waveform has been explained. However, as indicated by a broken line in FIG. 8, the position obtaining unit 802 can calculate the specific position based on the reflected light quantity calculated by the light quantity obtaining unit 803.

The signal processing unit 306 can be formed by a microprocessor (CPU) 811, a random access memory (RAM) 812 used by the CPU 811 as a work memory, a storage unit 813 such as a flash memory or read only memory (ROM) for storing a program to be executed by the CPU 811, and an input/output unit (I/O) 814 functioning as an interface between the control unit shown in FIG. 2 and the image capturing device 305. In this case, processing (to be described later) by the measurement unit 207 is implemented when the CPU 811 executes the program stored in the storage unit 813.

[Processing by Measurement Unit]

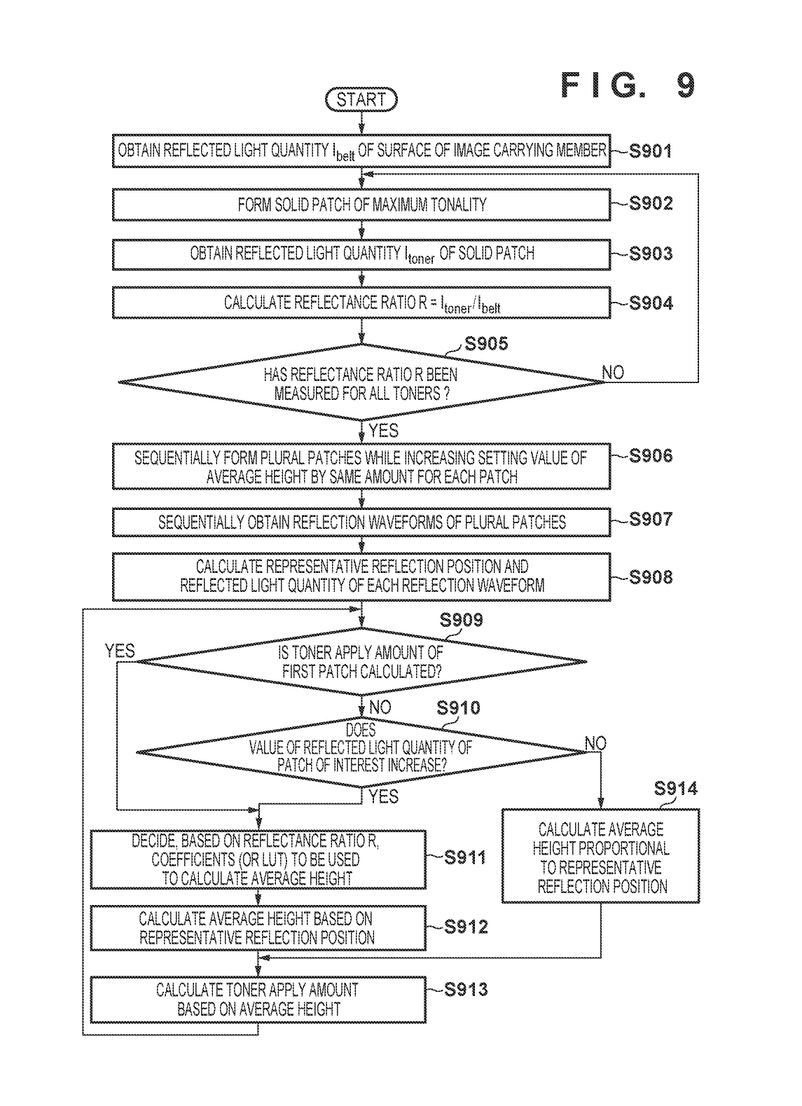

Processing by the measurement unit 207 from patch formation to toner apply amount calculation will be described with reference to a flowchart shown in FIG. 9.

The measurement unit 207 obtains a reflection waveform while the image carrying member 106 on which no patch is formed is illuminated with light, and causes the light quantity obtaining unit 803 to calculate the reflected light quantity I_{belt} of the surface of the image carrying member 106 (S901).

To measure the reflected light quantity of toner, the measurement unit 207 forms a solid patch of maximum tonality (S902), obtains a reflection waveform while the formed solid patch is illuminated with light, and causes the light quantity obtaining unit 803 to calculate the reflected light quantity Iₜₒₙₑᵣ of the solid patch (S903). The measurement unit 207 causes the decision unit 806 to calculate the reflectance ratio R=Iₜₒₙₑᵣ/I_{belt} based on the calculated reflected light quantities (S904).

By repeating the processes in steps S902 to S904 in accordance with determination in step S905, the reflectance ratio R is measured for all toners (for example, four toners of C, M, Y, and K) used by the printing apparatus, and data of the reflectance ratio R of each toner color is stored in the decision unit 806. Note that measurement (S901 to S904) of the reflectance ratio R need not be performed every time, and is performed when the environment in the printing apparatus largely changes, for example, after printing of a predetermined number of sheets, after reactivation of the printing apparatus main body, or after replacement of a toner cartridge.

Next, the measurement unit 207 sequentially forms a plurality of patches for measurement of a toner apply amount while increasing the setting value of an average height by the same amount for each patch (S906). The measurement unit 207 sequentially obtains the reflection waveforms of the plurality of patches (S907), and causes the position obtaining unit 802 and light quantity obtaining unit 803 to calculate the representative reflection position and reflected light quantity of each reflection waveform (S908).

If the toner apply amount of the first patch with the smallest setting value of the average height is calculated (S909), the determination unit 807 calculates an average height and calculates a toner apply amount without performing determination in step S910. That is, the decision unit 806 decides, based on the reflectance ratio R, an equation and coefficients or an LUT to be used by the average height calculation unit 804 (S911), the average height calculation unit 804 calculates an average height based on the representative reflection position calculated by the position obtaining unit 802 (S912), and the toner apply amount calculation unit 805 calculates a toner apply amount based on the average height (S913).

When calculating the toner apply amount of each of the second patch and subsequent patches, the determination unit 807 determines whether the value of the reflected light quantity of the patch of interest increases as compared with the reflected light quantity of the patch with the setting value of the average height smaller by one step (S910). As described above, for the first layer of the simple deposition model, the value of the reflected light quantity of the patch almost linearly increases. Therefore, if the value of the reflected light quantity increases, the average height in the first layer is corrected. That is, the decision unit 806 decides, in accordance with the reflectance ratio R, an equation and coefficients or an LUT to be used by the average height calculation unit 804 (S911), the average height calculation unit 804 calculates an average height based on the representative reflection position calculated by the position obtaining unit 802 (S912), and the toner apply amount calculation unit 805 calculates the toner apply amount based on the average height (S913).

On the other hand, if it is determined in step S910 that the value of the reflected light quantity does not increase, the measurement unit 207 determines that the layer is the second layer or a subsequent layer not to correct the average height. That is, the average height calculation unit 804 calculates an average height proportional to the representative reflection position calculated by the position obtaining unit 802 (S914), and the toner apply amount calculation unit 805 calculates a toner apply amount based on the average height (S913).

A description of end of the processing is not shown in FIG. 9. The processes in steps S909 to S913 are repeated the number of times corresponding to the number of patches, the toner apply amounts of which are to be calculated, and then the measurement unit 207 terminates the processing.

It is possible to correctly measure the average height of the patch of the simple deposition model formed on the image carrying member by correcting, using an image capturing device whose storage time is relatively long, the influence of the height of the patch on a measurement result when the exposed portion and toner covering portion of the image carrying member have different reflectances.

### Modification of Embodiment

### Influence of Shape of Reflection Waveform

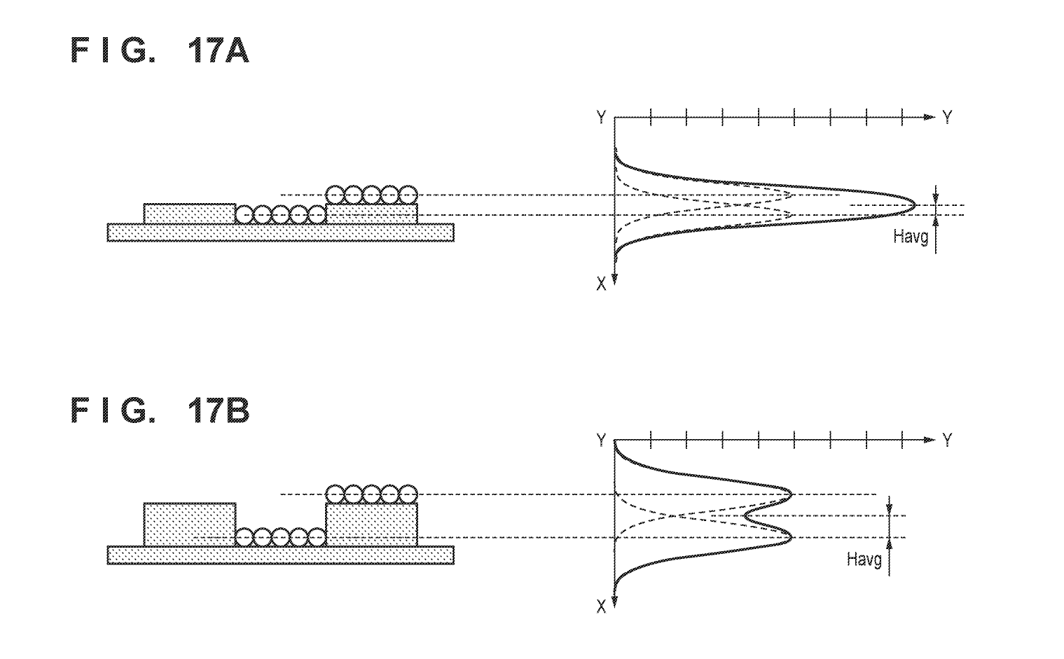

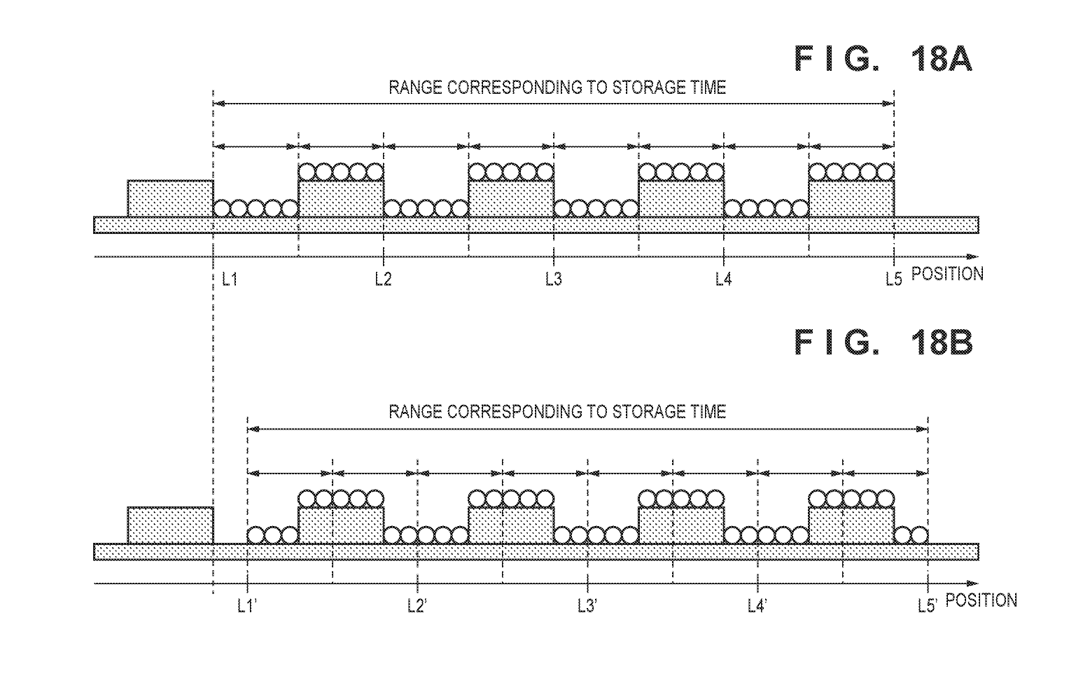

The reflection waveform obtained by the image capturing device 305 will be additionally explained. The shape of the reflection waveform indicated by image data output from the image capturing device 305 after a lapse of the storage time changes at the position Hb on the surface of the image carrying member 106 and the position Ht on the reflection surface of the patch. As shown in FIG. 17A, if the difference ΔH in height between the surface of the image carrying member 106 and the reflection surface of the patch is smaller than that in the case denoted by reference numeral 611 shown in FIG. 6, light reflected by each surface enters a pixel near the image capturing device 305, and thus the final reflection waveform has a thin shape with one peak.

On the other hand, if the difference ΔH in height between the surface of the image carrying member 106 and the reflection surface of the patch is larger than that in the case denoted by reference numeral 611 shown in FIG. 6, light reflected by each surface enters a pixel away from the image capturing device 305, and thus the final reflection waveform has a shape with two peaks.

If the peak of the reflection waveform is divided into two, it becomes difficult to correctly detect a representative reflection position when, for example, using an algorithm of specifying a position by detecting the maximum value of a signal. To the contrary, when using an algorithm of calculating the average position of the whole waveform by barycenter calculation or function fitting, it is possible to calculate the barycentric position of the final reflection waveform in any shape as the middle of the positions Ht and Hb without any influence of division of the peak. This tendency applies to a case in which the reflectance Ib of the image carrying member is different from the reflectance It of toner, as denoted by reference numeral 621 in FIG. 6, and it is possible to calculate the representative reflection position of the reflection waveform by performing calculation using a barycenter or function fitting without any influence of the shape of the reflection waveform.

[Storage Operation]

The storage operation in the image capturing device 305 will be additionally explained. FIG. 6 shows the example in which the storage time of the image capturing device 305 is set to obtain 10 reflected light beams corresponding to the screen period within one storage time. A longer storage time may be set to obtain an average reflection waveform for a plurality of screen periods.

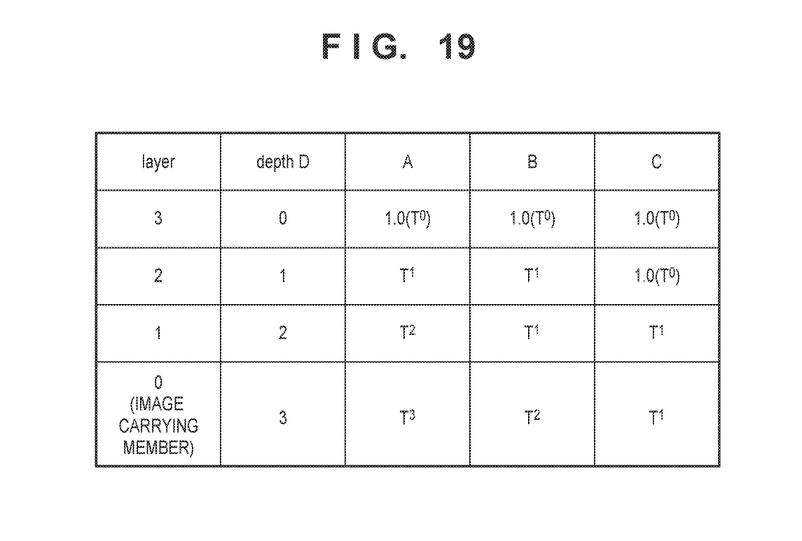

If a longer storage time is set, reflected light beams having the same intensity distribution (barycentric position) which are respectively reflected between positions L1 and L2, positions L2 and L3, positions L3 and L4, and positions L4 and L5 repeatedly enter the image capturing device 305, as shown in, for example, FIG. 18A. This increases the signal value of the reflection waveform to improve the S/N ratio but the shape (barycentric position) of the reflection waveform remains unchanged. Therefore, the above-described average height correction processing based on the reflected light quantity can be applied intact.

Furthermore, a timing at which the screen patch passes through the measurement position and a storage start timing may change. FIG. 18B shows an example in which the timing at which the screen patch passes through the measurement position and the storage start timing change from those shown in FIG. 18A. That is, referring to FIG. 18B, reflected light beams between the positions L1′ and L2′, positions L2′ and L3′, positions L3′ and L4′, and positions L4′ and L5′ repeatedly enter the image capturing device 305. In the case shown in FIG. 18B as well, since there are five reflected light beams entering for the screen period in each of the exposed portion and toner covering portion of the image carrying member, the ratio of the reflected light remains unchanged from the case shown in FIG. 18A.

Furthermore, the pitch of the screen lines may change. Since the size of one side of an inspection patch formed at the time of measurement of a toner apply amount in a general image forming apparatus is about 1 to 2 cm, if the patch is measured from one end to the other end, several hundred screen lines are included in the patch. If the average reflection waveform of the whole patch is obtained within a long storage time, the influences of the storage start timing and variations in formation of each screen line can be made small to be negligible. Setting a long storage time eliminates the need for adjustment of the storage start timing or setting of a storage time in accordance with a change in pitch of the screen lines, thereby facilitating a toner apply amount measurement procedure.

### Second Embodiment

The second embodiment of the present invention will be described below. The arrangement and basic operation of a printing apparatus according to the second embodiment are the same as in the first embodiment. The same reference numerals as in the first embodiment denote the same components and a detailed description thereof will be omitted.

In the first embodiment, the method of correcting the measurement value of the average height of the patch of the simple deposition model has been explained. The second embodiment will describe a method of correcting the measurement result of the average height of the screen patch of a three layer deposition model deposited to have a thickness of three layers.

[Three Layer Deposition Model]

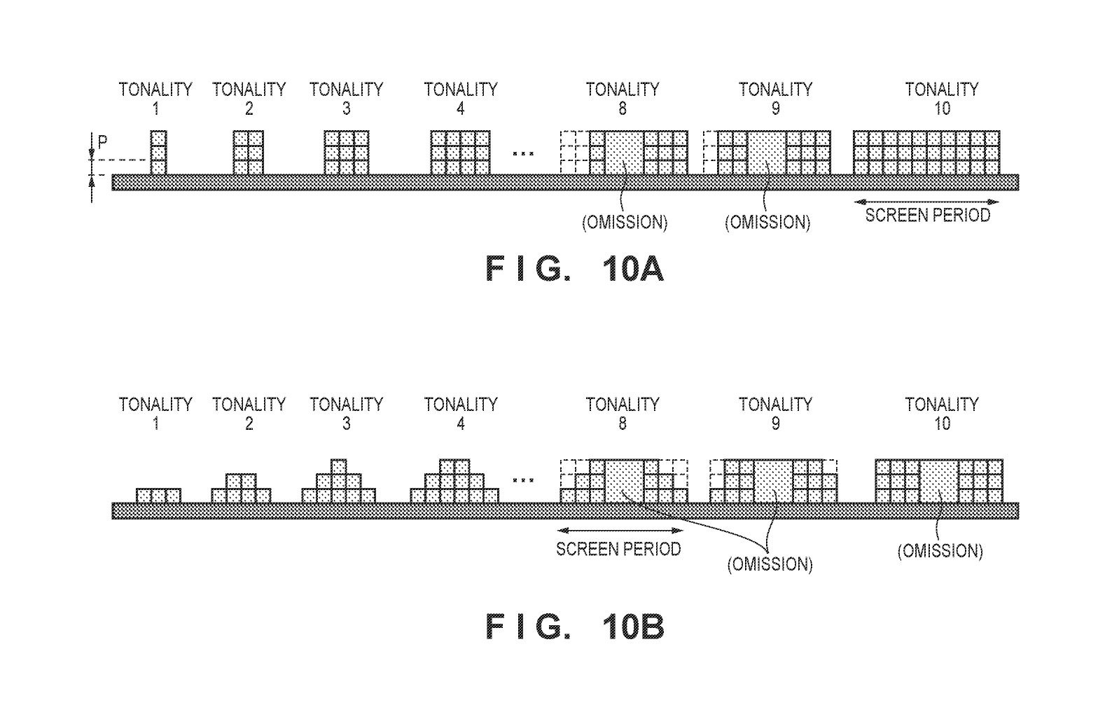

A solid patch of a general printing apparatus is formed to have a thickness of about several tens of μm. Therefore, if the thickness of the solid patch is converted into the number of toner particles each having a diameter of about several μm, this corresponds to two to three toner particles. Let P be the toner particle diameter. Then, the thickness of the solid patch is represented by 3P corresponding to three toner particles, and a screen period is represented by 10P corresponding to 10 toner particles. In this case, FIG. 10A schematically shows a case in which the screen line grows.

As shown in FIG. 10A, 10 tonalities are set from a toner absent state to a solid state (maximum tonality). As an ideal tonality expression, the width of the screen line changes to increase by one toner particle for each tonality, and the surface of an image carrying member corresponding to the width (screen period) of the screen line is covered with toner at tonality 10. In fact, however, toner is never deposited by limiting a range to a local surface region according to set tonality, and deposition collapses into a shape such that toner can be stably applied.

FIG. 10B shows a practical deposition state of the three layer deposition model. At tonality 1 or 2 of a low density, toner is not stacked in three layers, thereby obtaining a state in which deposition collapses in the horizontal direction. For example, if the first and second layers become stable as a base, the third layer starts to be formed at tonality 3, and then the width of the screen line gradually increases. For example, the surface of the image carrying member corresponding to the width (screen period) of the screen line is covered with toner at tonality 8.

As described above, as for the screen patch deposited in three layers, stack collapse of toner forming the screen line occurs, and thus the tonality (=average height) and the area of a toner covering portion are not always proportional to each other.

[Deposition State and Measurement Value of Average Height]

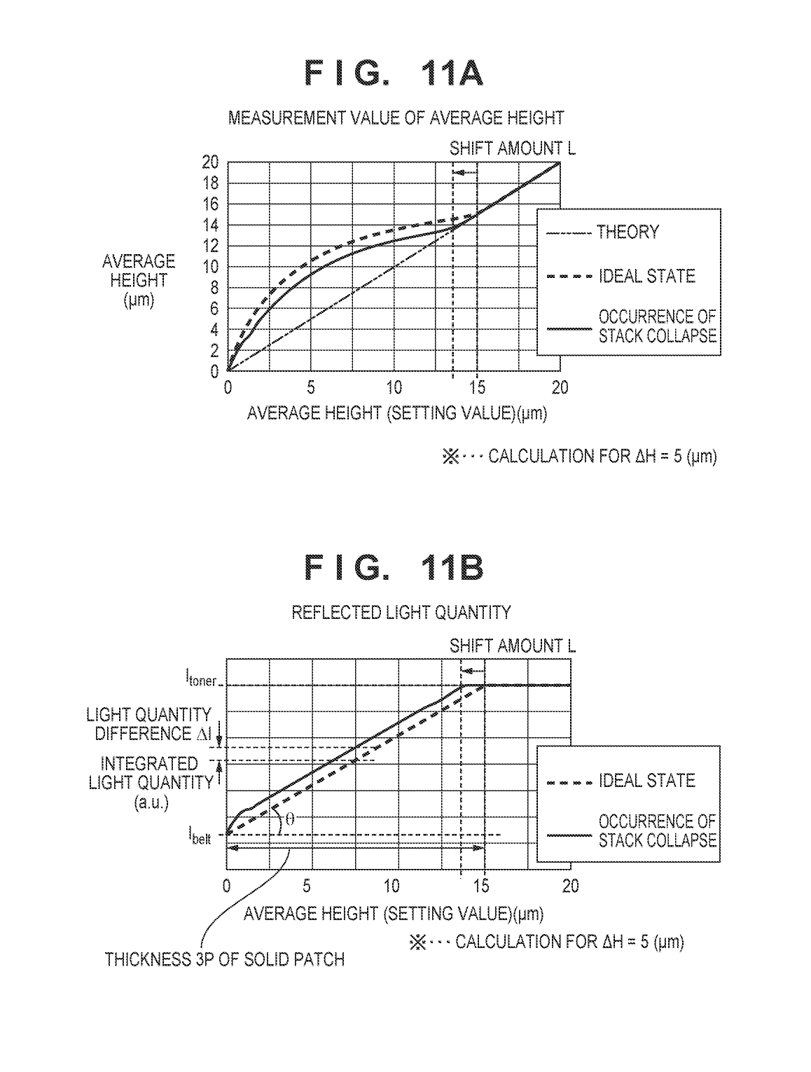

The measurement value of the average height and the reflected light quantity of the screen patch of the three layer deposition model will be described with reference to FIGS. 11A and 11B.

FIG. 11A shows the measurement value of the average height, and the basic characteristic is the same as that shown in FIG. 7B of the first embodiment. Note that in correspondence with an increase in the area of the toner covering portion caused by the occurrence of stack collapse in the screen patch of the three layer deposition model, a point (inflection point) at which the first layer is covered with toner to switch the characteristic to the linear characteristic slightly shifts to a region in which the setting value of the average height is small. Referring to FIG. 11A, the inflection point shifts by a measurement value L (to be referred to as a “shift amount L” hereinafter) of the average height. Note that the shift amount L corresponds to a shift of a representative reflection position obtained from the reflection waveform.

FIG. 11B shows the reflected light quantity, and the basic characteristic is the same as that shown in FIG. 7C of the first embodiment. However, since stack collapse has occurred, a point at which the first layer is covered with toner to saturate the reflected light quantity slightly shifts to a region in which the setting value of the average height is small. Referring to FIG. 11B, the saturation point shifts by the shift amount L.

[Correction of Average Height]

As for the screen patch of the three layer deposition model, a proper average height of the screen patch is calculated using the measurement value of the average height and the reflected light quantity in consideration of the characteristic of the measurement value of the average height and the characteristic of the reflected light quantity. Similarly to the first embodiment, since it is possible to represent a distorted portion of the measurement value of the average height by an equation such as a high-order polynomial or exponential function, it is possible to calculate a correct average height by performing correction using the equation for each type of toner. Note that it is necessary to decide the coefficients of the equation or an LUT in accordance with the shift amount L by which the inflection point shifts, due to stack collapse, to the region in which the setting value of the average height is small.

The shift amount L of the inflection point can be calculated based on reflected light quantities. A reflected light quantity I_{belt} of the surface of the image carrying member and a reflected light quantity Iₜₒₙₑᵣ of a solid patch (the setting value of the height is 3P) of maximum tonality which has no screen patch structure are measured in advance. Using the difference between the two reflected light quantities and the setting value 3P of the height of the solid patch, a slope θ of the reflected light quantity when no stack collapse occurs is calculated by:

tan θ=(Iₜₒₙₑᵣ−I_{belt})/3P (7)

Based on the calculated slope θ, the reflected light quantity when toner is ideally stacked for a setting value tP of a height of given tonality can be calculated by I_{ideal}=tan θ·tP. Therefore, as shown in FIG. 11B, it is possible to calculate the difference ΔI between the reflected light quantities when stack collapse occurs, based on an ideal reflected light quantity I_{idea} and a reflected light quantity It of an actually formed patch. The shift amount L is calculated based on the light quantity difference ΔI by:

L=ΔI/tan θ=(I_{idea}−It)/tan θ (8)

[Processing by Measurement Unit]

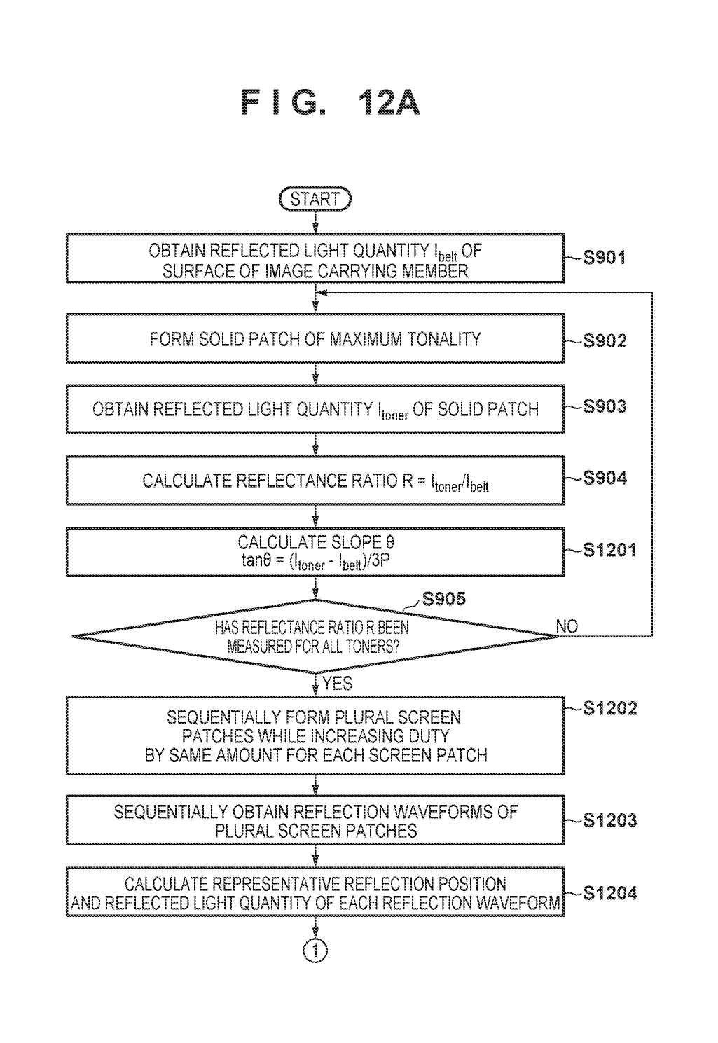

Processing by a measurement unit 207 from patch formation to toner apply amount calculation according to the second embodiment will be described with reference to flowcharts shown in FIGS. 12A and 12B. The same reference symbols as those shown in FIG. 9 of the first embodiment denote the same processes and a detailed description thereof will be omitted.

Following calculation (S904) of a reflectance ratio R, a decision unit 806 calculates a slope θ (tan θ) using equation (7) above (S1201). Note that similarly to measurement of the reflectance ratio R, measurement of the slope θ need not be performed every time, and is performed when the environment in the printing apparatus largely changes, for example, after printing of a predetermined number of sheets, after reactivation of the printing apparatus main body, or after replacement of a toner cartridge.

After the end of calculation (S904) of the reflectance ratio R and calculation (S1201) of the slope θ, the measurement unit 207 sequentially forms a plurality of screen patches for measurement of a toner apply amount while increasing a duty by the same amount for each screen patch (S1202). The reflection waveforms of the plurality of screen patches are sequentially obtained (S1203), and a position obtaining unit 802 and a light quantity obtaining unit 803 calculate the representative reflection position and reflected light quantity of each reflection waveform (S1204).

If the toner apply amount of the first screen patch with the smallest duty is calculated (S1205), the measurement unit 207 calculates an average height and calculates a toner apply amount without performing determination in step S1206. That is, using equation (8), the decision unit 806 calculates the shift amount L based on the difference ΔI between the reflected light quantity of the screen patch of interest and the ideal reflected light quantity I_{idea} obtained from the setting value tP of the height of the screen patch of interest (S1207). Note that it is possible to determine, based on the calculated shift amount L, whether the deposition model of the patch matches that shown in FIG. 10B.

Based on the reflectance ratio R and the shift amount L, the decision unit 806 decides an equation and coefficients or an LUT to be used by an average height calculation unit 804 (S1208). The average height calculation unit 804 calculates an average height based on the representative reflection position calculated by the position obtaining unit 802 (S912), and a toner apply amount calculation unit 805 calculates a toner apply amount based on the average height (S913).

When calculating the toner apply amount of each of the second screen patch and subsequent screen patches, a determination unit 807 determines whether the value of the reflected light quantity of the screen patch of interest increases as compared with that of the reflected light quantity of the screen patch with a duty smaller by one step (S1206). If the reflected light quantity of the screen patch of interest increases, calculation (S1207) of the shift amount L and decision (S1208) of an equation and coefficients or an LUT to be used by the average height calculation unit 804 are performed, thereby calculating the toner apply amount.

On the other hand, if it is determined in step S1206 that the value of the reflected light quantity does not increase, the measurement unit 207 determines that the first layer is covered with toner not to correct the average height. Similarly to the first embodiment, the average height calculation unit 804 calculates an average height proportional to the representative reflection position calculated by the position obtaining unit 802 (S914), and the toner apply amount calculation unit 805 calculates the toner apply amount based on the average height (S913).

As described above, as for the screen patch of the three layer deposition model, it is possible to correctly measure the average height of the screen patch formed on the image carrying member without any influence of a change in reflectance ratio caused by a toner deposition state, similarly to the first embodiment.

### Third Embodiment

The third embodiment of the present invention will be described below. The arrangement and basic operation of a printing apparatus according to the third embodiment are the same as in the first embodiment. The same reference numerals as in the first and second embodiments denote the same components and a detailed description thereof will be omitted.

In the first and second embodiments, the method of correcting the average height of a patch when toner particles are deposited densely and light is not transmitted has been explained. The third embodiment will describe a method of correcting the average height of a patch when light is transmitted through toner particles and a gap between toner particles.

[Deposition Structure and Measurement Value of Average Height]

The shape of pulverized toner or polymerized toner manufactured by a general method is not an ideal cube. Therefore, if light is emitted while actual toner is deposited, a region (to be referred to as a “particle illuminated region” hereinafter) where toner particles exist and are illuminated with the light and a region (to be referred to as a “gap illuminated region” hereinafter) where a gap between toner particles is illuminated with the light exist even in the same layer. In the particle illuminated region and the gap illuminated region, even if the distribution of toner particles is locally biased due to the diameter of the toner particles and a degree of overlapping of the toner particles, the toner particles are considered to be distributed at a given ratio when globally seeing the overall patch. Therefore, in the third embodiment, it is possible to calculate the average height of a screen patch by defining a spherical toner model.

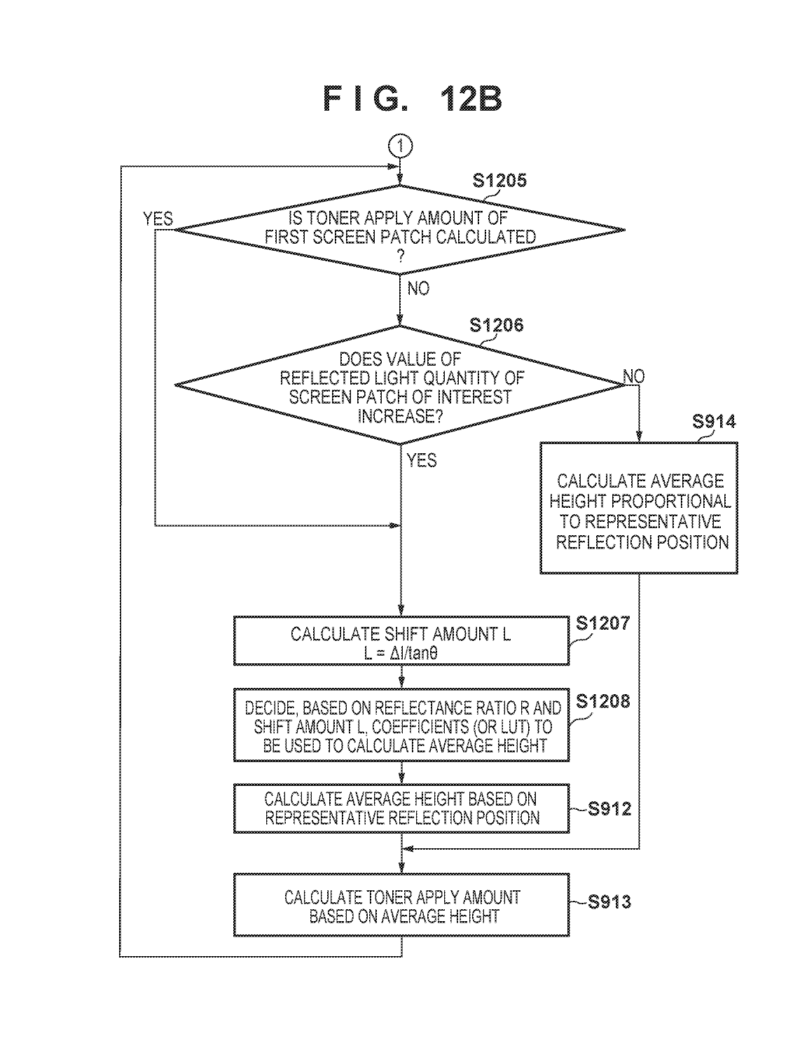

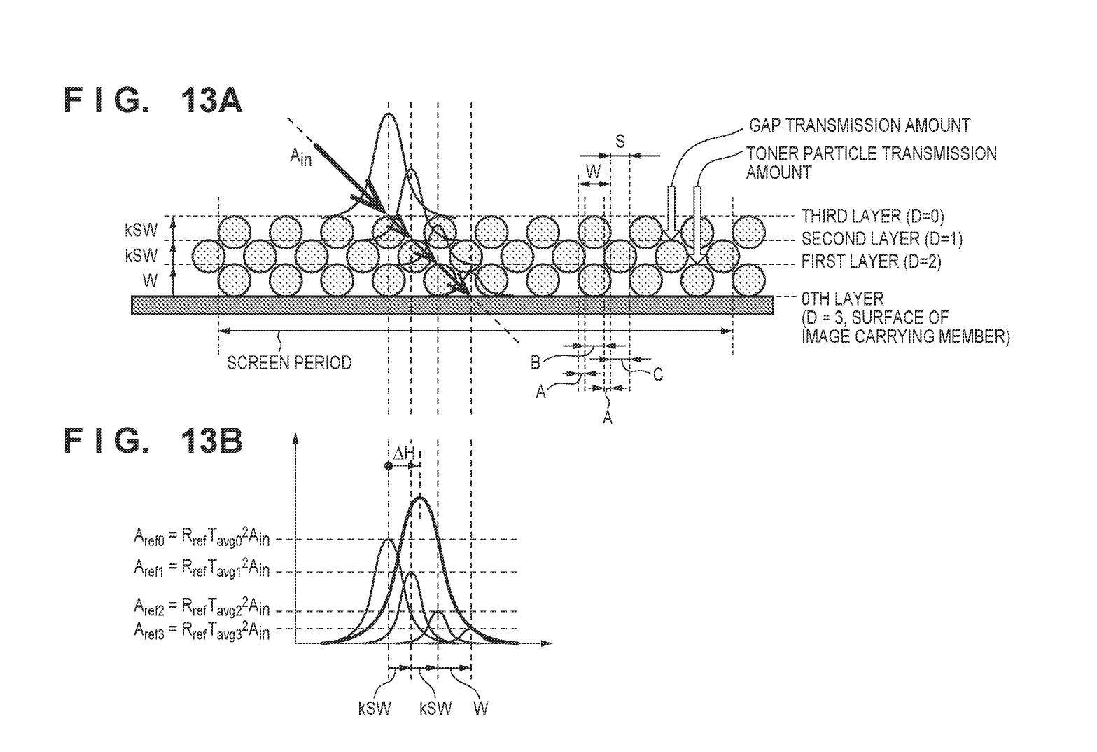

A reflection waveform when spherical toner is deposited will be described with reference to FIG. 13A.

When spherical toner is deposited across a plurality of layers, a region is divided into particle illuminated regions and gap illuminated regions by focusing attention on a given layer. A combination of toner particle stack states when the particle illuminated regions and gap illuminated regions are stacked across the plurality of layers can be defined as a combination of three states A, B, and C shown in FIG. 13A, as a representative example.

In stack state A, toner particles in all the layers are illuminated with light. In stack state B, toner particles in odd-numbered layers (the first and third layers in FIG. 13A) are illuminated with light, and gaps in even-numbered layers (the second layer in FIG. 13A) are illuminated with light. In stack state C, gaps in the odd-numbered layers are illuminated with light, and toner particles in the even-numbered layers are illuminated with light.

Assume that the transmittance of the gap is 1.0 and the transmittance of the toner particle is T (<1). In stack state A, light is transmitted through the toner particles in all the layers, and the transmission amount of illumination light attenuates by the transmittance T for each layer. Therefore, when the number of layers is defined by D, the transmittance is T^{D} when light is transmitted up to the deepest Dth layer.

In stack state B, light is transmitted through the toner particles in the odd-numbered layers. Therefore, when illumination light is transmitted up to the deepest Dth layer, the transmittance can be represented by T^{ceil(D/2)} using, for example, a ceiling function of rounding up the decimal part.

In stack state C, light is transmitted through the toner particles in the even-numbered layers. Therefore, when illumination light is transmitted up to the deepest Dth layer, the transmittance can be represented by T^{floor(D/2)} using, for example, a floor function of discarding the decimal part.

The transmittance of light is summarized as shown in FIG. 19. FIG. 19 shows the transmittance of light which is transmitted through each layer in each stack state.

Therefore, when a gap ratio S and a toner particle diameter W (=1−S) are defined as the area ratio between the particle illuminated region and gap illuminated region, an average transmittance T_{avgD} of light transmitted up to the deepest Dth layer in the three stack states is given by:

T_{avgD}=(1−2S)T_{D}+ST^{ceil(D/2)}+ST^{floor(D/2)} (9)

Light emitted from a light source to a patch reaches the surface of each layer while attenuating by the average transmittance T_{avgD} given by equation (9). After the light is reflected by the surface of each layer, it attenuates by the average transmittance T_{avgD}, and exits from the surface of the patch. That is, when the intensity distribution of illumination light is defined as a Gaussian function, parameter A representing the peak height indicating the intensity of the light attenuates by the square of the transmittance. Let Aᵢₙ be the illumination intensity of the light source and R_{ref} be the reflectance of the spherical toner or an image carrying member. Then, the peak height of a reflection waveform having a Gaussian distribution shape, which is reflected by the surface of each layer and observed by an image capturing device 305, is given by:

A_{refD}=R_{ref}T_{avgD}²Aᵢₙ (10)

The incident angle of the light is about 45°, and the position of the reflection waveform having the Gaussian distribution shape, which is reflected by the surface of each layer, shifts by an amount corresponding to a thickness W of the layer. In the first layer, since toner particles are deposited on the image carrying member, the shift amount is W. In each of the second layer and subsequent layers, since toner particles in the upper layer fall into gaps in the lower layer, the shift amount is obtained by multiplying the thickness W by the gap ratio S and a coefficient k.

Reflection waveforms indicated by reflected light beams from the respective layers, which are obtained by the above spherical toner deposition model, are overlaid at each position at each intensity, and observed by the image capturing device 305 as a combined waveform. FIG. 13B shows the observed reflection waveforms. Referring to FIG. 13B, since components which are transmitted into the layers and reflected at lower positions are included, the barycenter of the combined waveform shifts rightward by ΔH, as compared with a case in which light is reflected by only the surface of the patch.

[Measurement Value of Average Height]

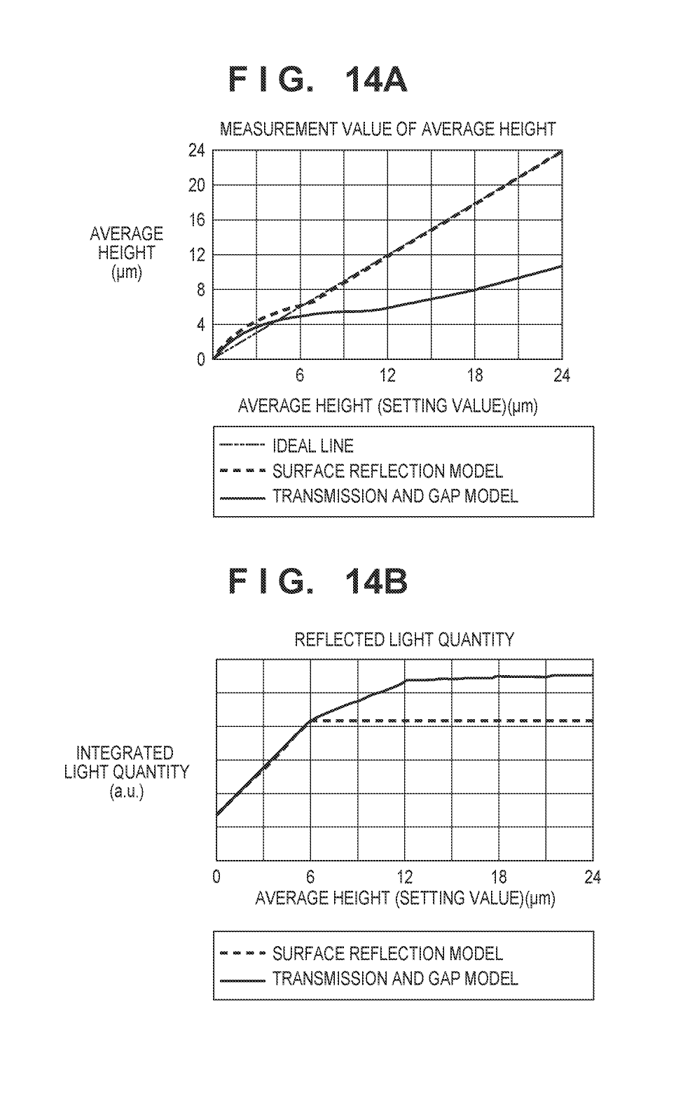

The measurement value of the average height and the reflected light quantity of a patch in the spherical toner deposition model will be described with reference to FIGS. 14A and 14B.

A case will be described here in which a screen period corresponds to 10 spherical toner particles, as shown in FIG. 13A, and the width of the screen line of the first layer gradually increases as the set density of the patch increases, similarly to the first embodiment. After the first layer is formed, the second layer and subsequent layers are sequentially formed.

FIG. 14A shows the measurement value of the average height of a model (to be referred to as a “surface reflection model” hereinafter) in which light is reflected by only the surface of a patch, and the measurement value of the average height of a model (to be referred to as a “transmission and gap model” hereinafter) which considers light transmission and a gap between toner particles. As for the surface reflection model, after the end of formation of the first layer, there is no reflection from the lower layer, and thus the measurement value of the average height linearly changes.

On the other hand, as for the transmission and gap model, even after the end of formation of the first layer, there is light which is transmitted through the second layer and reflected by the surface of the lower layer (the first layer or the image carrying member), and thus the measurement value of the average height is relatively small. In addition, since the intensity of light reflected within the patch successively changes along with an increase in toner deposition amount, the measurement value of the average height includes no conspicuous inflection point.

FIG. 14B shows the reflected light quantity. Similarly to the measurement value of the average height shown in FIG. 14A, even after the end of formation of the first layer, only the intensity of light reflected within the patch changes, and the reflected light quantity exponentially changes.

[Correction of Average Height]

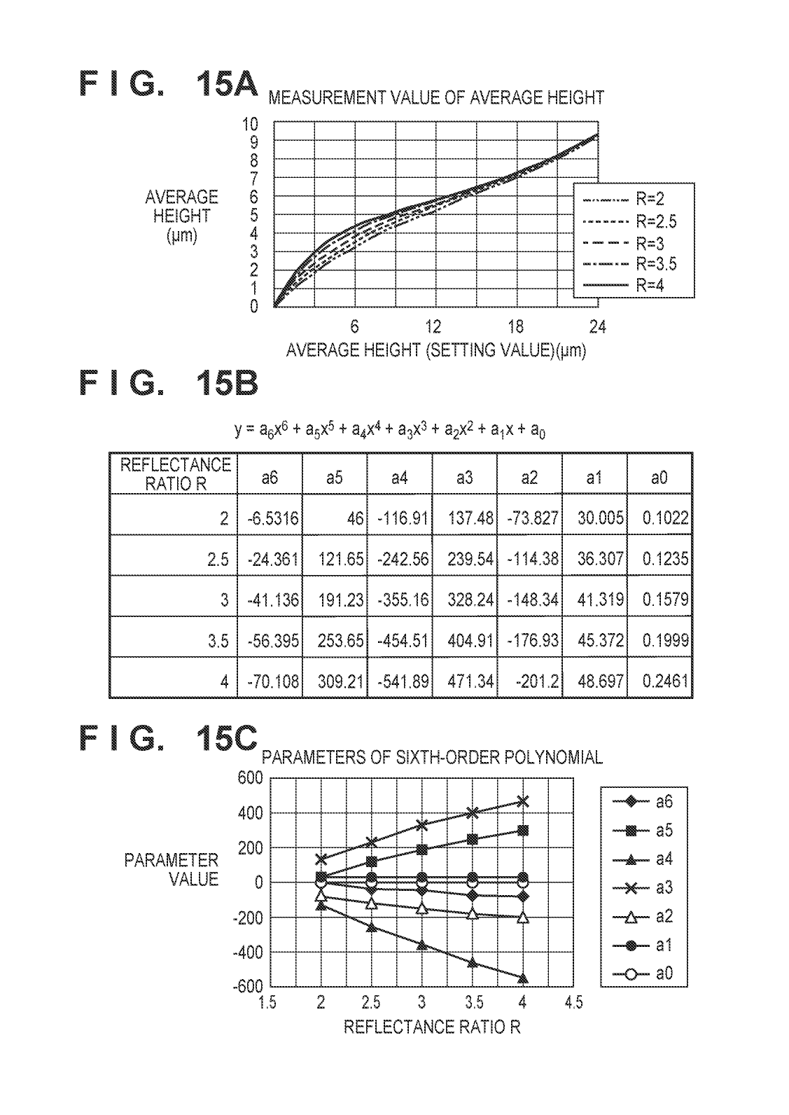

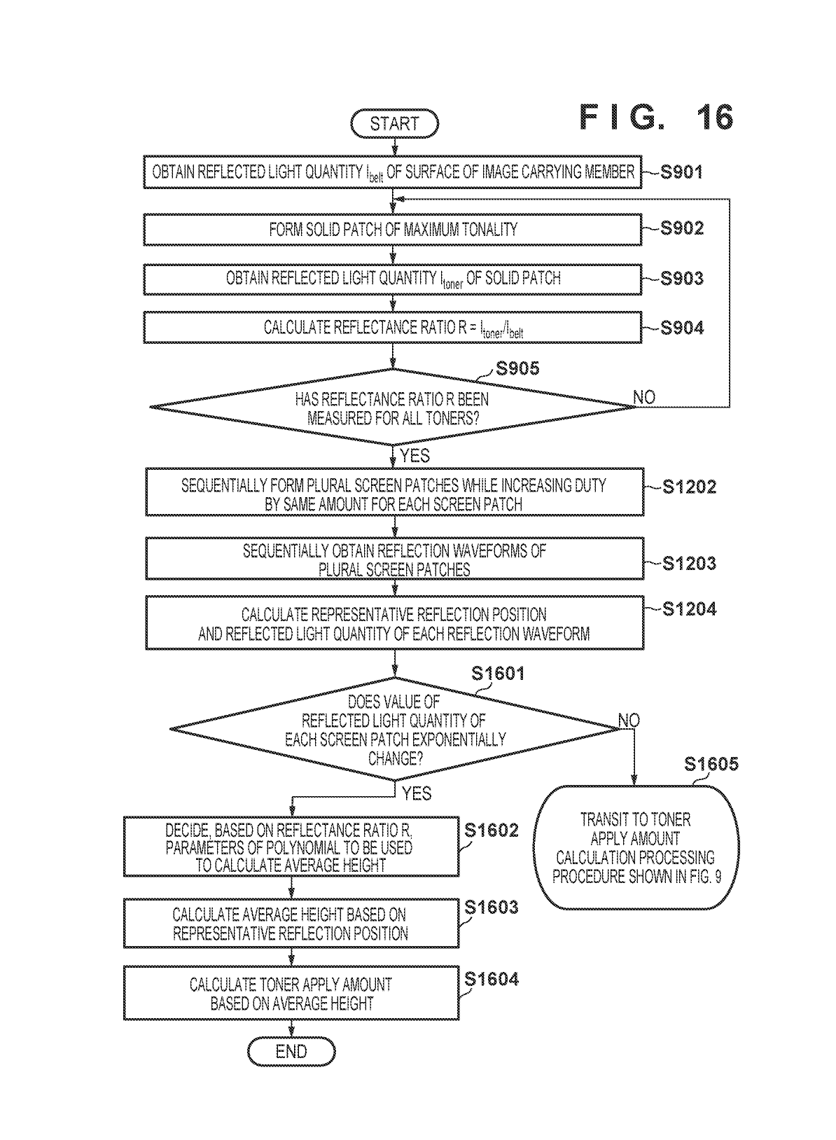

A method of correcting the measurement value of an average height according to the third embodiment will be described with reference to FIGS. 15A to 15C.

FIG. 15A shows the measurement value of the average height when the reflectance ratio R of toner with respect to the image carrying member changes. As the reflectance ratio R becomes higher, the measurement value at the time of formation near the first layer increases. A curve indicating the measurement value can be expressed by, for example, a sixth-order polynomial.

FIG. 15B shows parameter examples when the measurement value at a given representative reflectance ratio R is fitted by the sixth-order polynomial. FIG. 15C shows changes in parameters with respect to the reflectance ratio R. It is possible to correct the measurement value of the average height by holding the parameters, and measuring a reflected light quantity I_{belt} of the image carrying member and a reflected light quantity Iₜₒₙₑᵣ of the patch to calculate the reflectance ratio R.

Note that since the above-described correction method is applicable to a deposition model in which spherical toner is deposited for each layer, it is inappropriate for another deposition model having a different deposition state. Whether the spherical toner deposition model is used can be determined by detecting whether the reflected light quantity exponentially changes.

[Processing by Measurement Unit]

Processing by a measurement unit 207 from patch formation to toner apply amount calculation according to the third embodiment will be described with reference to a flowchart shown in FIG. 16. The same reference symbols as those in FIG. 9 of the first embodiment or FIGS. 12A and 12B of the second embodiment denote the same processes and a detailed description thereof will be omitted.

A determination unit 807 determines whether the value of the reflected light quantity of each of a plurality of screen patches obtained in step S1204 exponentially changes (S1601). If the value of the reflected light quantity exponentially changes, a decision unit 806 decides, based on the reflectance ratio R, the parameters of a polynomial to be used by an average height calculation unit 804 with reference to FIG. 15B or 15C (S1602).

The average height calculation unit 804 uses the polynomial and the decided parameters to calculate the average height of each screen patch based on the representative reflection position of each screen patch calculated by a position obtaining unit 802 (S1603). A toner apply amount calculation unit 805 calculates the toner apply amount (a physical amount necessary for control) of each screen patch based on the average height of the screen patch (S1604).

On the other hand, if it is determined in step S1601 that the value of the reflected light quantity does not exponentially change, a measurement unit 207 determines that the method of correcting the measurement value of the average height according to the third embodiment is inappropriate, and transits to, for example, the toner apply amount calculation processing procedure according to the first embodiment shown in FIG. 9 (S1605). Alternatively, in this case, the measurement unit 207 may output a warning indicating that no appropriate feedback control is performed, thereby terminating the process.

As described above, even for the deposition model in which toner particles are not densely deposited and light is transmitted through the toner particles and a gap between the toner particles, it is possible to correctly measure the average height of a screen patch.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)®), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-035627 filed Feb. 25, 2015 which is hereby incorporated by reference herein in its entirety.

What is claimed is:

1. A measurement apparatus for measuring an average height of a patch formed on an image carrying member using a toner, and a tonality of the patch being determined by a deposition state of the toner, the apparatus comprising:
a measurement unit configured to illuminate light with a surface of the image carrying member which is moved, and a patch formed on the image carrying member so as to obtain an intensity distribution of reflected light from the surface of the image carrying member and the patch;
a first obtaining unit configured to obtain a representative reflection position of the reflected light from the patch based on the intensity distribution;
a second obtaining unit configured to obtain a light quantity of the reflected light from the patch based on the intensity distribution; and
a calculation unit configured to calculate the average height of the patch based on the light quantity and the representative reflection position.

2. The apparatus according to claim 1, further comprising a decision unit configured to obtain first intensity of reflected light from the surface of the image carrying member and second intensity of reflected light from a solid patch corresponding to a maximum tonality, and to calculate, as a reflectance ratio, a ratio of a reflectance of toner using formation of the solid patch to a reflectance of the surface of the image carrying member based on a ratio of the second intensity to the first intensity.

3. The apparatus according to claim 2, wherein the calculation of the reflectance ratio is performed for all toners used in an image forming apparatus having the image carrying member.

4. The apparatus according to claim 2, wherein the patch is one of a plurality of patches in which setting values of the average height increase at a regular interval,
wherein the measurement unit sequentially obtains the intensity distribution of reflected light from each of the plurality of patches,
wherein the first obtaining unit obtains a reflection waveform indicating the intensity distribution of reflected light from each patch, and obtains a peak position or barycentric position of the reflection waveform as the representative reflection position of the screen patch, and
wherein the second obtaining unit obtains the reflection waveform indicating the intensity distribution of reflected light from each patch, and calculates the light quantity of the patch based on a height or area of the reflection waveform.

5. The apparatus according to claim 4, wherein the decision unit decides an expression and coefficients, or a lookup table used in the calculation of the average height based on the reflectance ratio.

6. The apparatus according to claim 5, further comprising a determination unit configured to determine whether or not the light quantity of a patch of interest increases relative to the light quantity of a patch corresponding to one-step small setting value,
wherein, in a case when it is determined that the light quantity of the patch of interest increases, the calculation unit calculates the average height from the representative reflection position using the decided expression and coefficients, or the decided lookup table.

7. The apparatus according to claim 6, wherein, in a case when it is determined that the light quantity of the patch of interest does not increase, the calculation unit calculates the average height proportional to the representative reflection position.

8. The apparatus according to claim 2, wherein the patch is one of a plurality of screen patches, each of which has an exposed portion and a toner covering portion of the image carrying member, the tonality of each screen patch depends on a duty of the exposed portion and the toner covering portion, and duties of the plurality of screen patches increase at a regular interval,
wherein the measurement unit sequentially obtains the intensity distribution of reflected light from each of the plurality of screen patches,
wherein the first obtaining unit obtains a reflection waveform indicating the intensity distribution of reflected light from each screen patch, and obtains a peak position or barycentric position of the reflection waveform as the representative reflection position of the screen patch, and
wherein the second obtaining unit obtains the reflection waveform indicating the intensity distribution of reflected light from each screen patch, and calculates the light quantity of the screen patch based on a height or area of the reflection waveform.

9. The apparatus according to claim 8, wherein the decision unit calculates a shift amount of the representative reflection position from the light quantity of each screen patch, and an ideal light quantity of the screen patch calculated based on a difference between the first and second intensities, and a setting value of a toner height of the solid patch, and
wherein the decision unit decides an expression and coefficients, or a lookup table used in the calculation of the average height based on the reflectance ratio and the shift amount.

10. The apparatus according to claim 9, further comprising a determination unit configured to determine whether or not the light quantity of a screen patch of interest increases relative to the light quantity of a screen patch corresponding to one-step small duty,
wherein, in a case when it is determined that the light quantity of the screen patch of interest increases, the calculation unit calculates the average height from the representative reflection position using the decided expression and coefficients, or the decided lookup table.

11. The apparatus according to claim 10, wherein, in a case when it is determined that the light quantity of the screen patch of interest does not increase, the calculation unit calculates the average height proportional to the representative reflection position.

12. The apparatus according to claim 8, further comprising a determination unit configured to determine whether or not light quantities of the reflected light from the plurality of screen patches indicate an exponential increase,
wherein, in a case when it is determined that the light quantities indicate the exponential increase, the decision unit decides parameters of a polynomial used in the calculation of the average height based on the reflection ratio.

13. The apparatus according to claim 12, wherein, in the case when it is determined that the light quantities indicate the exponential increase, the calculation unit calculates the average height from the representative reflection position using the polynomial and the decided parameters.

14. An image forming apparatus comprising:
a measurement unit configured to measure an average height of a patch formed on an image carrying member using a toner, a tonality of the patch being determined by a deposition state of the toner; and
a control unit configured to control an image forming process based on the measured average height of the patch,
wherein the measurement unit comprises:
a measuring unit configured to illuminate light with a surface of the image carrying member which is moved, and a patch formed on the image carrying member so as to obtain an intensity distribution of reflected light from the surface of the image carrying member and the patch;
a first obtaining unit configured to obtain a representative reflection position of the reflected light from the patch based on the intensity distribution;
a second obtaining unit configured to obtain a light quantity of the reflected light from the patch based on the intensity distribution; and
a calculation unit configured to calculate the average height of the patch based on the light quantity and the representative reflection position.

15. The apparatus according to claim 12, wherein the control unit comprises:
an exposure control unit configured to control an exposure process included in the image forming process;
a developing control unit configured to control a developing process included in the image forming process; and
a transfer control unit configured to control a transfer process included in the image forming process.

16. A method of measuring an average height of a patch formed on an image carrying member using a toner, and a tonality of the patch being determined by a deposition state of the toner, the method comprising:
illuminating light with a surface of the image carrying member which is moved, and a patch formed on the image carrying member so as to obtain an intensity distribution of reflected light from the surface of the image carrying member and the patch;
obtaining a representative reflection position of the reflected light from the patch based on the intensity distribution;
obtaining a light quantity of the reflected light from the patch based on the intensity distribution; and
calculating the average height of the patch based on the light quantity and the representative reflection position.

17. A non-transitory computer readable medium storing a computer-executable program for causing a computer to perform a method of measuring an average height of a patch formed on an image carrying member using a toner, and a tonality of the patch being determined by a deposition state of the toner, the method comprising:
illuminating light with a surface of the image carrying member which is moved, and a patch formed on the image carrying member so as to obtain an intensity distribution of reflected light from the surface of the image carrying member and the patch;
obtaining a representative reflection position of the reflected light from the patch based on the intensity distribution;
obtaining a light quantity of the reflected light from the patch based on the intensity distribution; and
calculating the average height of the patch based on the light quantity and the representative reflection position.
